(19) United States
(12) Patent Application Publication
(10) Pub. No.: US 2025/0268277 A1
(43) Pub. Date: Aug. 28, 2025

(54) A SUNFLOWER SEED PROTEIN CONCENTRATE AND PROCESS FOR THE PRODUCTION THEREOF

(71) Applicant: Avril, Paris (FR)

(72) Inventors: Olivier GALET, Trégueux (FR); Mbalo NDIAYE, Saint Jacques De La Lande (FR); Marine BIANEIS, Le Rheu (FR)

(21) Appl. No.: 18/245,486

(22) PCT Filed: Sep. 17, 2021
(86) PCT No.: PCT/EP2021/075724

§ 371 Date: Mar. 15, 2023

(30) Foreign Application Priority Data
Sep. 17, 2020 (EP) 20306045.4

(51) Int. Cl. A23J 1/14; A23J 3/14

(52) U.S. Cl. CPC A23J 1/142; A23J 3/14

(57) ABSTRACT

A process for producing a protein concentrate from sunflower seed and a sunflower seed concentrate. The process comprises the successive steps of:
a) providing a press cake from oilseed, said oilseed being at least partially dehulled before being pressed, wherein said press cake is not extracted with hexane
b) washing said press cake by mixing it with a first acidic aqueous solution to obtain an aqueous-washed oilseed meal;
c) washing said aqueous-washed oilseed meal by mixing it with a first alcohol solvent, to obtain a first alcohol-washed oilseed meal, wherein said first alcohol solvent is a hydrous or a non-hydrous alcohol and has an alcohol concentration which is above 75% w/w; and
d) separating said alcohol-washed oilseed meal from said solvent to obtain said protein concentrate. The concentrate has a protein content of at least 55% dry matter w/w, preferably at least 65% dry matter w/w, and less than 80% dry matter w/w (N×6.25); and a content of polyphenol compounds of less than 2% dry matter w/w, preferably equal or less than 1% dry matter w/w.

### CROSS-REFERENCE TO RELATED APPLICATIONS

This application is a National Stage Entry of International Application No. PCT/EP2021/075724, filed Sep. 17, 2021, which claims priority to EP Application No. 20306045.4, filed Sep. 17, 2020, the disclosures of each of which are hereby incorporated by reference in their entirety.

### FIELD OF THE INVENTION

The invention relates to a process to extract (purify) and/or concentrate proteins from sunflower oilseeds. The invention further relates to the product thus obtained, which is suitable for applications in food or feed.

### PRIOR ART

Sunflower seeds are an important source of proteins having a high nutritional value. In particular, proteins contained in some oilseeds are now widely used in the food or feed industry as, for example, food or food additives, food stabilisers, or as a major nutritious component. These proteins are usually obtained after the seeds (dehulled or not) are crushed and pressed to remove most of the oil and the residual press cake (or cake or expeller) is extracted, generally using hexane, to recover the remainder of the oil. The residual meal from the solvent extraction contains residual hexane and is commonly known as “white flake”. The solvent is recovered from the meal for re-use before the meal is usually disposed of by a Desolventizer-Toaster. In the solvent recovery process, the oilseed meal is often heated to a higher temperature of about 120° C. to 140° C. in a procedure termed “toasting”. Hexane is obtained from petrochemical sources. It is now regarded as generally desirable to avoid using hexane in the production of foodstuff.

One of the challenges of sunflower protein concentration is the presence of polyphenols, and particularly chlorogenic acid, which impart an undesirable greenish colour or hue to the concentrate.

Rahma et al. (1981) reports several aqueous-alcoholic protein recovery processes for the production of sunflower protein concentrates from dehulled and hexane-extracted defatted meal (flours) obtained according to the method described by Rahma et al. (1979). Aqueous ethanol and acidic n-butanol and a mixture thereof were tested by washing the meals at room temperature 2 to 4 times. This produced unsatisfactory results. Although chlorogenic acid is removed to some extent, the use of these organic solvents is associated with a decrease of nitrogen solubility index (NSI) and a denaturation of the proteins. The use of aqueous ethanol decreases fat absorption, emulsification and foaming capacity.

Saeed et al. (1988) reports a process wherein a hexane-extracted sunflower seed meal is treated with acidic-butanol-1 (a solvent also obtained from petrochemical sources) to provide a low polyphenol protein concentrate. More than 8 extractions are recommended, which are time and cost consuming. The authors teach than using acidic butanol-1 failed to yield a product that did not turn brown at alkaline pH. In order to compare NSI data, protocols used in the prior art, when available, were replicated to enable meaningful comparisons (see Table 8a),

The same effect of denaturation (or conformational changes) of the proteins have been reported by G. Sripad et al. (1987). The use of methanol or ethanol (around 40%) was also described on hexane-extracted, i.e. highly defatted meals.

More recently WO 02/060273 A1 (TNO) describes a method to remove phenolic compounds from an aqueous extract of a sunflower meal using inter alia ethanol at a concentration of up to 30%. It is further described that a concentration of ethanol ranging from 5 to 15% (v/v) together with a pH adjustment at pH 5 is beneficial to the removal of polyphenols.

WO 2013/013949 A1 (DSM IP ASSETS) describes that the concentration of ethanol can be increased up to 70% aqueous ethanol when used on an aqueous extract of an oilseed cake in order to precipitate the protein, this to obtain a very pure isolate. It discloses that ethanol allows the removal of phytates and phenolic compounds (including chlorogenic acid) which are perceived as “anti-nutritional”.

As there are increased demands for protein concentrates having particular profiles in terms of colour, low amounts of polyphenols, and/or in particular low amount of chlorogenic acid, increased or enhanced digestibility, emulsifying capacity, nitrogen solubility profile, viscosity profile and/or water holding capacity; there is a need for a sunflower protein concentrate having at least one, and preferably many, of these desirable characteristics as well as for a process suitable for preparing such a protein concentrate on an industrial scale and/or providing a high yield of protein at limited costs without the use of hexane. Due to the great number of goals to reach, optimising a purification process to obtain a cost effective method and a quality product has proven to be a most difficult and challenging task.

Furthermore sustainability and durability of the food chain make apparent the benefit of minimally processed foodstuff and it is another object of the invention to provide a method to obtain these protein rich compositions using a minimum of steps and/or energy.

These challenges are compounded when the extraction is carried out on a sunflower seed meal containing up to 15 wt. %, generally from 3 to 12 wt. % of oil or fat as the presence of fatty compounds reduces the efficient removal of polyphenols, and in particular of chlorogenic acid, during the extraction processes.

### DESCRIPTION OF THE INVENTION

It is therefore an object of the invention to provide a method to obtain a protein concentrate from sunflower seeds which can use sunflower press cakes, or non-organic solvent (e.g., hexane) extracted sunflower meals.

It is a further object of the invention to provide a protein concentrate from these oilseeds having at least one of the following characteristics:
a colour with no detectable green hue (in powder form or in an aqueous solution at pH 9);
an increased proportion of fibre compared to the sunflower seeds;
a low amount of polyphenols and, in particular, a low amount of chlorogenic acid;
an amino acids profile close to the one of sunflower seeds;
an increased or enhanced digestibility, emulsifying capacity, nitrogen solubility profile, viscosity profile and/or water holding capacity;
being obtainable using the process of the invention;
being suitable for applications in food or feed; and
being hexane-free, that is having no traces of hexane, or an amount well below the acceptable trace amount, in its composition.

Alternatively, or additionally, it is also an object of the invention to provide a process to obtain a concentrate of sunflower seeds proteins which is more environmentally friendly by using green solvents and/or minimising the use and/or the amount of organic solvents.

Alternatively, or additionally, it is also an object of the invention to provide a process to obtain a concentrate of sunflower seed proteins which is more environmentally friendly by using green solvents, such as water and alcohol and/or avoiding the use of hexane, and/or, more generally, alkane and other non-polar solvents, such as benzene, toluene, diethyl ether, chloroform and/or 1,4-dioxane, and/or aprotic solvents such as ethyl acetate, THF, dichloromethane, acetone, MeCN, DMF and/or DMSO.

According to a first general aspect of the invention it is provided a process for producing a sunflower seed protein concentrate from oilseed, said process comprising the successive steps of:
a) providing a press cake from oilseed, said oilseed being sunflower seeds such as from the Helianthus annuus L. species, said oilseed being at least partially dehulled before being pressed, wherein said press cake is not extracted with hexane;
b) washing said press cake by mixing it with a first acidic aqueous solution to obtain an aqueous-washed oilseed meal;
c) washing said aqueous-washed oilseed meal by mixing it with a first alcohol solvent, to obtain a first alcohol-washed oilseed meal, wherein said first alcohol solvent is a hydrous or a non-hydrous alcohol and has an alcohol concentration which may be above 75% w/w; and
d) separating said alcohol-washed oilseed meal from said solvent to obtain said protein concentrate.

Such a process, or method, allows obtaining a high quality concentrate on an industrial scale.

A distinction between protein “concentrates” and protein “isolates” is made due to the production and the resulting protein content. Plant protein isolates have a very high protein content of at least 80 wt. % on dry matter (N×6.25) compared to plant protein concentrates which have a protein content ranging from 55 wt. % and less than 80 wt. % on dry matter (N×6.25). Usually, to prepare protein isolates, the proteins are dissolved in water (not comprising large amount of alcohol) and then isolated from the aqueous solution.

### Oilseed/Starting Material

In this specification the oilseeds are from a sunflower plant, i.e. a plant belonging to the family Asteraceae and from the genus Helianthus, in particular the common sunflower: Helianthus annuus L. The term sunflower used in this specification encompasses not only common sunflower but also all the members of the genus. Although almost whole of the sunflower oilseed production is in fact from common sunflower, other species of oilseeds from the genus, as well as new varieties of plant, or variants, obtained by crossbreeding or genetic modifications are also encompassed by the term “sunflower” which is used in its broadest possible sense as the process of the invention can be applied to the oilseeds produced by member of the genus.

The press cake used is obtained from at least “partially” dehulled oilseed (Helianthus seeds). Processing steps of oilseed dehulling are well known in the art (Laisney, 1984; Matthaus, 2012). The dehulling step includes removing the hull from the oilseed. The dehulling step produces a “dehulled oilseed” or oilseed kernels. At the industrial scale, the dehulling is generally partial. By “partially dehulled oilseed”, it is meant that 10% w/w, preferably 50% w/w, more preferably 75% w/w, most preferably 90% w/w of the hull has been removed from the oilseed. The oilseed is preferably completely (i.e. fully) dehulled.

Therefore, the use of fully dehulled seeds (i.e. kernels) as starting material is specifically encompassed by the invention. According to a preferred embodiment of the invention, the sunflower seeds used in the process of the invention are kernels. Kernels consist, or consist essentially of fully dehulled sunflower seeds. By “consist essentially” it is meant that the seeds used are at least 95%, preferably 98% and more advantageously 99% kernels in weight percent over the total dry matter weight (%/DM w/w). The use of kernels, combined with the process of the invention results in a product which has straight white colour, which is pleasing to the consumers and which, when dissolved within water at basic pH does not have any unappealing greenish hue.

Oilseed kernels or dehulled seed can advantageously be cracked into smaller particles and then possibly flattened into thin flakes, especially if they are cooked before screw pressing. Processing steps of oilseed flaking are well known in the art (Laisney, 1984; Unger, 1990; Matthäus, 2012). In certain embodiments, the oilseed can be preheated before flaking at a temperature generally ranging from 30° C. to 50° C. The flaking step produces a “flaked oilseed”. The flaking step is achieved in a flaking mill, through flaking rolls.

### Pressing

Processing steps of oilseed pressing are well known in the art (Laisney, 1984; Unger, 1990; Matthäus, 2012). The pressing step includes partially removing the oil from the oilseed, i.e., removing at least 60% (w/w) of the oil from the oilseed.

The oilseed press cake to be used in the method according to the present invention is preferably obtained by cold-pressing, i.e. the seeds are preferably not cooked prior to its passing through the press. In another embodiment, the oilseed can be extruded (advantageously at a temperature not beyond 130° C. for 1 min) prior to its passing through the press. In the press, the seeds (e.g. kernels) are crushed and some of the seed oil is thus expelled. Even during the pressing step, it is preferred that the temperature of the oilseed does not go beyond 85° C., preferably not beyond 80° C., more preferably not beyond 74° C., most preferably not beyond 70° C. The pressing step is achieved (mechanically) in a press, preferably a screw press. The process is advantageously carried out at a temperature above room temperature such as equal to, or above, 22° C. A preferred screw press is a barrel-type screw press with vertically split hinged barrel, such as the type commercially available from CPM SKET GmbH (Germany) or MBU20 sold by the French Company OLEXA (Feuchy, FR). Other press manufacturers include French Oil Mill Machinery (USA), De Smet Rosedowns (United-Kingdom), Farmet (Czech republic), Reinartz (Germany), etc. According to an advantageous embodiment of the invention, the moisture content of the oilseed at the inlet of the press, or before the pressing, is ranging from 2% to 8%, preferably from 3% to 7%, e.g. 6%. Hence the process of the invention may advantageously include a step of moisturizing and/or drying the oilseed prior to carrying out the pressing step, in order to achieve the advantageous moisture content. In another advantageous embodiment of the invention, the temperature of the oilseed at the inlet of the press, or prior to the pressing step, is ranging from 10° C. to 40° C., preferably from 10° C. to 30° C., more preferably from 18° C. to 25° C., most preferably 20° C. to 22° C. The appropriate moisture content or temperature of the oilseed can be obtained by heating the over-moist/cold oilseed at a temperature of 50° C. or less prior to pressing, preferably at a temperature ranging from 30° C. to 40° C. This would be particularly suitable when, for example, the oilseed is stored under particular cold (e.g. winter) or wet conditions.

Due to press friction during the pressing step, the temperature of the oilseed is increasing. However, the temperature of the oilseed during the pressing step shall be maintained as of 80° C. or less and by order of increasing preference 75° C. or less, 72° C. or less, 69° C. or less, most preferably 67° C. or less. As it will be easily understood, it is also advantageous that the temperature does not drop too low. The temperature lower limit is generally considered to be about or above room temperature, e.g. 22° C. Advantageously, the temperature of the resulting oilseed press cake at the press outlet is ranging from 50° C. to 75° C., preferably 60° C. to 70° C. The pressing step produces an “oilseed press cake”, also named “oilseed expeller” and are usually in the shapes of flakes. The pressing step according to the present invention can be repeated at least twice (double-pressing or more). According to a preferred embodiment of the invention the sunflower seed press cake has an oil content ranging from 5% to 30% dry w/w, in particular from 6% to 15% dry w/w. This is substantially a higher fat content than the one of a hexane-defatted meal. The oil content of the oilseed press cake can depend on the temperature of the oilseed during the pressing or the number of pressing steps. By way of example, the sunflower seed press cake obtained by cold-pressing at a temperature of 74° C. or less (e.g. 64° C. to 72° C.) can have an oil content ranging from 7% to 20% dry matter w/w, in particular from 7% to 15% dry matter w/w, more particularly from 7% to 12% dry w/w or from 8 to 14% dry matter w/w, determined by a Soxhlet extraction method (preferably according to the Standard NF ISO 6492-B (2011)).

The press cake can be in the shape of flakes, such as the ones directly obtained from the expeller, or can be in the shape of a powder or flour, which can be obtained by milling or grinding the press cake obtained from the press.

According to a particularly preferred aspect of the invention, the sunflower seed, the pressed sunflower seed (i.e., sunflower seed press cake) used in the process of the invention, and more generally the product obtained according to the process of the invention, is not treated, extracted, or generally obtained, with a non-polar and/or aprotic solvent and, in particular, is not treated with hexane also called “n-hexane”. Thus, the product obtained from the method of the invention is not contacted with such a solvent at any time during the process and the process does therefore not include the use of such a compound or compounds. Hence the process and/or the product of the invention are hexane-free and preferably free of non-polar solvents and/or polar aprotic solvents; Compounds with dielectric constants of less than 15 are considered to be non-polar.

### First (Acidic Aqueous) Wash

According to the invention the sunflower press cake is washed, at least once, by mixing it with a first acidic aqueous solution to obtain an aqueous-washed oilseed meal. The acidic aqueous solution comprises obviously water, which can be pure water (aqua) or drinking water. The pH of the mixture is advantageously adjusted to range from 4.0 to 5.2, preferably 4.4 to 5.2, more preferably from 4.6 to 5.0 and most preferably from 4.7 to 4.9. This adjustment can be made by any means known to skilled person but preferably comprises the use of water which is acidified beforehand. For example, this acidification can be carried out by adding an acid such as the ones mentioned below. The use of phosphoric acid was found satisfactory. The acidified water can have a lower pH than the one which is sought to be achieved within the mixture. Using acidified water having a pH ranging from 1.5 to 3, in particular a pH of around 2, has demonstrated good results.

In order to adjust the pH of the mixture, once the (preferably acidified) water has been added to the press cake, a component acting as a pH regulator, such as an acid or a base (alkali), can be added. For example, this component can be a mineral or a salt such as an alkali, (e.g. NaOH, Ca(OH)2 and/or Na2CO3), or a strong acid such as sulfuric acid or hydrochloric acid, or a weak acid, such as lactic acid, citric acid, propionic acid, ascorbic acid, phosphoric acid or sodium bisulphite, preferably phosphoric acid. Phosphoric acid at a suitable concentration (e.g. 75% (v/v), or 1 M) is preferred.

It is further preferred that the acidic aqueous liquid used to wash the oilseed press cake does not contain an alcohol.

The weight ratio of (sunflower seed press cake):(water) used can range from 1:15 to 1:4 w/w, preferably 1:10 to 1:6, e.g. about 1:8. The term water in this ratio encompasses the mass of water as well as the mass of acidified water, if the water is acidified prior to be added to the press cake.

According to a particular embodiment of the invention, the temperature set during the extracting, or acidic aqueous washing, step is ranging from 45° C. to 65° C., preferably from 50° C. to 65° C. and most preferably from 55° C. to 60° C. Such a temperature range is beneficial as it prevents the development of pathogens such as E. coli while avoiding structural changes in proteins and undesirable interactions of the proteins with phenolic and/or sugars components.

According to another advantageous embodiment of the invention the residence time of the sunflower seed meal within the aqueous solution may range from 1 minute to 90 minutes, preferably from 1 minute to 30 minutes. According to a particularly advantageous embodiment it was found that a short residence time such as from 1 minute to 10 minutes, and even from 1 to 5 minutes can be sufficient. Other embodiments include residence time from 10 minutes to 90 minutes, preferably around 30 minutes to 60 minutes, most preferably from 40 minutes to 50 minutes, e.g. around 45 minutes.

As it is usual the aqueous solution and the sunflower seed meal can generally be admixed together by general stirring. When the acidic aqueous washing step is over, the solid can be separated from the liquid (spent aqueous solution) by usual liquid-solid separation such as decantation, filtration with a meshed material, membrane or cloth (e.g. 10 μm meshed material). Decantation means, in particular a centrifugation step, is preferred. Such a step can be carried out with standard decanter which can develop centrifugal forces speed of 3000 to 5000 g, preferably around 4000 g.

The washing step can be carried in a tank, such as an agitated filter tank, a jacketed reactor, an extractor, such as an immersion extractor, or a percolation extractor (e.g., shallow bed percolation extractor). The solid material within the mixture is a sunflower press cake, that is, a de-oiled sunflower seed meal. The term “de-oiled” is not meant to describe a product where no oil remains; it simply describes the fact that compared with the starting sunflower seeds, the resulting product presents less oil. Once the acidic aqueous washing step has been carried out the resulting solid is an aqueous-washed sunflower meal.

According to an embodiment of the invention it is considered that repeating the acidic washing step could be advantageous. In particular repeating this step more than once, preferably more than twice, in particular more than 4 times could improve the outcome.

According to a particularly preferred embodiment of the invention, the process of the invention comprises only one acidic washing step and not several, as it has surprisingly been found that satisfactory results can be achieved using a single wash. The economy of water connected with a process with limited amount aqueous wash is highly beneficial to the environment and to the cost effectiveness of the process.

### Second (Alcohol) Wash

According to the process of the invention the aqueous-washed oilseed meal is then washed by mixing it with a first alcohol solvent, to obtain a first alcohol-washed oilseed meal. The first alcohol solvent is a hydrous, a non-hydrous or an azeotrope mixture of alcohol and has preferably an alcohol concentration which may be above 75% w/w. Preferably an azeotrope (alcohol with a few percent water is used).

The alcohol contained in the alcohol solvent is preferably chosen in the group of C1 to C20 aliphatic organic compounds, branched or not branched, that carry at least one hydroxyl functional group, and their mixture thereof. According to another preferred embodiment of the invention the alcohol solvent is a lower (C1 to C6) aliphatic alcohol, such as ethanol, isopropanol, methanol, or a mixture thereof, preferably isopropanol or ethanol. As amongst these, ethanol is the alcohol which appears the most suitable.

As it is well known and well understood in the art, alcohols are hydrophilic compounds and usually contain in their commercial form a small amount of water. Hence the alcohol to be used can contains a small amount of water, in general 96% (w/w), and in particular 96% (w/w) ethanol (also called “ethanol”), is the alcohol concentration most commonly used, but higher concentration, such as up to 99% (e.g. absolute alcohol) can also be used. This step can be repeated, hence there can be two, three, four etc . . . alcohol washes.

Advantageously the step of washing with an alcohol solvent is repeated no more than once.

The alcohol solvent can comprise higher amounts of water and include what is generally known as aqueous alcohol, wherein the percentage of alcohol is about 70% (w/w), the remaining compound being water.

However better results are obtained with solvent containing a higher concentration of alcohol. It is recommended that the solvent has an alcohol concentration of alcohol over water ranging from 75% to 99% (w/w), preferably from 80% to 99% (w/w), for example 96% (w/w). The alcoholic solvent can comprise or consist of the aqueous azeotrope of the selected alcohol, or mixtures thereof that is 96% w/w for ethanol, and 88% w/w for isopropanol, preferably +/−2% (w/w). It was surprisingly found that, succeeding to an acidic aqueous washing step, using an alcohol-concentrated solvent has a lower denaturing effect and/or maintains an acceptable NSI towards the sunflower seed proteins.

The use of an alcohol solvent comprising at least 94% (w/w) and preferably 96% (w/w) of alcohol, and preferably ethanol, the remaining compound being water (or aqua), is highly preferred.

Other compounds, in particular polar solvent(s) and especially a protic solvent, to the exclusion of water, can be used in association with the alcohol. However, according to a preferred embodiment, only alcohol(s) is used to minimise the costs and the environmental consequences of the process. It should be noted that the term “an alcohol” used in the present specification encompasses mixture of alcohols.

Preferably, the sunflower seed aqueous-washed meal is mixed with the alcohol solvent according to a weight ratio (solids):(alcohol solvent) ranging from 1:2 to 1:8 w/w, preferably 1:3 to 1:4, e.g. about 1:3.5.

According to a particular embodiment of the invention, the temperature set during the alcohol washing step is set below the evaporation temperature of the solvent. It preferably ranges from 45° C. to 67° C., preferably from 55° C. to 65° C., and in particular around 60° C.

According to another advantageous embodiment of the invention, the residence time of the aqueous-washed oilseed meal within the alcohol solvent may range from 5 minutes to 60 minutes, preferably around 7 minutes to 50 minutes, most preferably from 10 minutes to 40 minutes, e.g. around 10 to 30 minutes. Surprisingly a short residence time of the aqueous-washed oilseed meal within the alcohol solvent, such as ranging from 1 minute to 10 minutes, or even from 1 to 5 minutes was shown to be sufficient and is therefore particularly advantageous.

As it is usual the alcohol solvent and the aqueous-washed sunflower seeds meal can generally be admixed together by general stirring. The aqueous-washed sunflower meal used in this step may already contain a certain amount of water remaining from the previous process step. The minimum amount of alcohol within this wash may be of at least about 50% (w/w), preferably at least 70% (w/w) and advantageously at least, or around, 80%±2%.

A higher concentration of alcohol may be used, for example a concentration of from 90 to 96% (w/w), pure (99% (w/w)) or azeotropic (e.g. 96% in the case of ethanol). In this case, the substrate can be subjected to a drying step before the wash in order to reduce the quantity of water, or other solvents, it contains.

The washing steps can be carried out using successive batches or a continuous process carried out by using a conventional extractor apparatus used to extract fat from the aqueous-washed sunflower meal. For example the alcohol solvent may percolate through the aqueous-washed sunflower meal which is positioned on a perforated belt which travels horizontally. Miscella percolates through the belt and falls into compartments in the bottom of the extractor housing, where it is picked up by a series of pumps and recirculated counter currently at the required increasing concentration to the sunflower meal. For another example the extraction may be carried out by using a solvent immersion extractor wherein the aqueous-washed sunflower meal is continuously convoyed through the extractor in counter current mode with the alcohol solvent.

It is however a particularly advantageous aspect of the process according to the invention that a direct solid/liquid separation is sufficient between these two different washes and that there is no need to carry out separate drying or desolventizing steps between the different washes. This is due to the particular combination of solvents used, i.e. water and alcohol (and in particular ethanol), which are compatible and in particular miscible one within the other.

When the washing step is over, the solid is separated from the liquid (spent first alcohol solution) by usual liquid-solid separation as described above in reference with the acidic washing step.

According to an embodiment of the invention it has been found that to repeat the extracting or washing step at least once is advantageous, especially if:
lowering the amount of oil and the chlorogenic acid from the protein concentrate; or
enhancing its water holding capacity, oil holding capacity or emulsifying capacity (ml), in particular the water holding capacity;
   is a specific aim. In particular it was found that repeating the alcohol washing step once lead to concentrate having such properties.

Thus, according to a particularly preferred embodiment of the invention, the process of the invention may comprise only one or two alcohol washing step, as it has surprisingly been found that satisfactory results can be achieved using a single or at most two alcohol washes. The economy of alcohol connected with a process using limited amount of alcohol solvent is highly beneficial to the environment and to the cost effectiveness of the process. The fact that a drying or desolventizing step may not be required between washing steps is another important energy-saving feature.

It should be noted, that only two washing steps, one being an acidic aqueous wash and the other an alcohol solvent wash, can be sufficient to satisfactorily eliminate the chlorogenic acid from the oilseed concentrate.

When more than one alcohol washing step is carried out, it can be beneficial to use a recycled solvent (that is the spent first alcohol solvent which was used from a previous extracting, or washing, step) for all of the repeated steps. Alternatively, recycled solvent and fresh solvent can be both used each for a distinct wash/step. It may also be more economical to use a mixture of fresh and recycled alcohol for some or all of the steps.

The minimum amount of alcohol within a second alcohol wash may be at least about 65% (w/w), preferably at least 85% (w/w) and advantageously at least, or around, 94%±1% (w/w). A higher concentration of alcohol may be used, for example pure (99% (w/w)) or azeotropic alcohol (e.g. 96% in the case of ethanol). In this case, the washed proteins can be subjected to a drying step before the wash in order to reduce the quantity of water, or other solvent, it contains.

The spent solution(s) (the first and subsequent solvent) above described are rich in free chlorogenic acid (CGA). CGA can therefore be extracted from this solution for further uses.

According to an advantageous embodiment of the invention the pH during the alcohol washing step can be adjusted. This pH can be adjusted to range from 6 to 7.5 and is advantageously set to 6.5±0.2.

In order to adjust the pH of the first solution (solvent) a component acting as a pH regulator, such as an acid or a base, can be added. For example, this component can be a mineral or a salt such as an alkali, (e.g. NaOH), or a strong acid, or a weak acid, such as the ones mentioned before.

As it is usual, when the alcohol washing step is over the solid is separated from the liquid by usual liquid-solid separation as described above in reference to the acidic washing step. The solid thus obtained is a protein concentrate according to the invention.

### Desolventizing/Drying

According to a preferred embodiment of the invention, the protein concentrate is subjected to a desolventizing step which may be achieved under partial vacuum, using, for example, a vacuum paddle dryer; a drying stove or a laminar flow hood. in particular a Paddle vacuum Dryer, Double Cone Dryer or a Down Draft Desolventizer (DDD). A drying oven or a double cone vacuum dryer can also be used. Alternatively, it can be achieved in tank or reactor wherein the process has taken place by applying a vacuum (e.g. 0.1 to 0.2 bar) and at a convenient temperature (e.g. below 70° C., preferably below 60° C.). The use of a vacuum allows to minimise denaturation of the proteins. According to an advantageous embodiment of the invention the residence time of the concentrate sunflower seed protein is ranging from 100 minutes to 200 minutes, preferably 120 minutes. Advantageously the temperature is lower than 70° C., preferably lower than 60° C. For example, the temperature is ranging from 50 to 60° C., preferably for about 180±10 mins.

Desolventizing/drying steps can also be used within the process of the invention as intermediary steps to dry, i.e. remove some or most of the solvent or moisture, from the solids. For example it can advantageously be used between subsequent washes. This permits to better remove one solvent, e.g. water, when another solvent, e.g. (aqueous) alcohol, is to be used. It also allows, as described above, to prevent, or minimize, the dilution of the next solvent. It also may improve the efficacy of the previous washing step by removing more undesirable components dissolved within the solvent.

Advantageously, the oilseed protein concentrate is dried to reach a moisture content ranging from 5% to 10%. This step produces a “dry oilseed protein concentrate”.

### Sieving (Sorting)

The dry oilseed protein concentrate can be subjected to at least one sieving (or sorting) step. Sieving technologies are well known in the art. For example, one can use a sieving or plansifter machine or a triboseparator. However, when the press cake is made from kernels (completely dehulled seeds) this step is usually not required and can be omitted.

### Milling-Micronising

Additionally, or alternatively, the dried oilseed protein concentrate can be transformed into a powder, such as a micronized powder. This step can be carried out by using a milling technology such as air jet mill or impact mill. Advantageously, the oilseed protein concentrate has a D50 (μm) average particle size comprised, between 25 μm and 100 μm, preferably between 25 μm and 50 μm, more preferably between 25 μm and 40 μm, in particular between 30 μm and 40 μm.

It has been found that the oilseed protein concentrate having a D90 (μm) average particle size superior to 80 μm and preferably ranging from 80 μm to 150 μm, preferably from 90 μm and 120 μm, more preferably from 90 μm and 110 μm (e.g. around 100 μm), have particularly good organoleptic properties and in particular a good mouthfeel.

Advantageously, the oilseed protein concentrate has a D99 (μm) average particle size comprised, between 400 μm and 800 μm, preferably between 450 μm and 500 μm, more preferably between 460 μm and 480 μm. The average size particle of the sunflower protein concentrate before and after milling can be measured using laser diffraction (Mastersizer 2000, Malvern, cell, dispersion unit Hydro 2000, dispersant: Alcohol, refractive index: 1,52, Absorption: 0,1). This optional milling step allows obtaining a homogenous product.

A micronized powder, or flour, is therefore another object of the invention. Preferably the powder, or flour, is a white powder. Such a white powder is obtainable according to the process of the invention, in particular when the press cake used is a press cake obtained from kernels, that is, seeds which are dehulled.

### Other

According to one embodiment of the process of the invention, the alcohol used is ethanol, and preferably ethanol at 96% (w/w) in all of the alcohol-using processing steps.

According to one embodiment of the process of the invention, the oilseed is not flaked prior to step a).

According to another embodiment of the process of the invention, it does not comprise a microfiltration or diafiltration step.

According to yet another embodiment of the process of the invention, it does not comprise the use of a cyclone concentrator or a cyclone concentration step.

The washing steps of the process of the invention advantageously include removing (extracting) at least some undesirable molecules (UM) such as carbohydrates (monosaccharides, disaccharides and oligosaccharides) and phenolic compounds such as chlorogenic acids, from the defatted oilseed meal. Carbohydrates, or sugars, include monosaccharides (such as fructose, glucose, and galactose), disaccharide (sucrose), and alpha-galactosyl derivatives of glucose, among which most common are the trisaccharide raffinose, the tetrasaccharide stachyose, and the pentasaccharide verbascose.

According to a particularly preferred other embodiment of the invention the process does not dissolve the sunflower seed proteins to be concentrated in water at an alkaline/basic pH. These proteins to be concentrated may advantageously stay in a solid or undissolved state throughout the process of the invention. Thus, the concentration of the desirable proteins can be achieved mainly through dissolving and washing away unwanted components (e.g. fat, carbohydrate, albumins, etc.) and drying, or desolventizing, the proteins remaining in the meal.

According to another variant of the process according to the invention a thermic heat treatment could be applied to the oilseed protein concentrate This treatment could be applied in order to prevent bacteria growth and/or to modify the protein functionalities and be carried out at a temperature ranging from 60° C. to 95° C., for example for 1 to 10 days.

### Second General Aspect of the Invention

According to a second general aspect of the invention, it is disclosed a process which is particularly adapted to the purification of oilseed press cakes which have only been defatted mechanically (i.e. by applying pressure) and not chemically (i.e. by the use of a hexane or another non-polar and/or aprotic solvent). This “natural” press cake has a different composition from solventized press cake (e.g. a higher fat content). To remove undesirable or unwanted components while preserving the structure of the protein is therefore challenging. It has been surprisingly found that removal of fat had not to be prioritized over removal of water-soluble compounds and could be carried out afterwards.

This process according to the invention for producing a protein concentrate from oilseed, thus comprises the successive steps of:
providing a press cake from oilseed, said oilseed being seeds from a plant of the genus Helianthus and more particularly from the species Helianthus annuus L., said oilseed being at least partially dehulled before being pressed, wherein said press cake is not extracted with hexane;
washing said press cake by mixing it with a first solvent to obtain a first solvent-washed oilseed meal, wherein the phytic acid content thereof is reduced by at least 40% dry matter w/w compared to the one of said press cake, in particular from 40% to 80% dry matter w/w, more particularly between 50% and 75% dry matter w/w, and wherein the total content of phenolic compounds thereof is reduced by at least 30% dry matter w/w compared to the one of said press cake, preferably at least 40% dry matter w/w, in particular from 40% to 99% dry matter w/w;
washing said first solvent-washed oilseed meal by mixing it with a second solvent, to obtain a first second-washed oilseed meal, wherein the protein content thereof is increased by at least 15% dry matter w/w compared to the one of the press cake, in particular from 15% to 20% dry matter w/w, and wherein the fat content thereof is reduced by at least 50% dry matter w/w compared to the one of the press cake, in particular from 50% to 90% dry matter w/w, more particularly from 55% to 85% dry matter w/w; and,
separating said second solvent-washed oilseed meal from said solvent to obtain said protein concentrate.

The first and second solvents can be respectively water (in particular an acidic aqueous solution) and an alcohol (in particular a hydrous, a non-hydrous or an azeotrope mixture of alcohol) as described with reference to the first general aspect of the process of the invention. In fact, as the skilled person will understand, all preferred aims, objects, features, aspects, embodiments and conditions above described with reference to the process according to the first general aspect of the invention will readily apply to this process according to the second general aspect of the invention and are also preferred objects of this process. However, washing steps other than the ones described with reference to the first general aspect of the process of the invention can be considered. The particular nature of the wash can be directly determined once it is known that phytic acid and phenolic compounds have to be removed first and up to a certain amount and that fat removal is to be dealt with in second.

### Sunflower Seed Protein Concentrate

As mentioned before a particular object of the invention is a sunflower protein concentrate.

Another object of the invention is an oilseed protein concentrate obtained or obtainable by a process of the present invention as described therein.

According to another object of the invention the sunflower seed protein concentrate of the invention comprises an amino acid profile which is very similar to the one of the sunflower seeds of origin. In particular, the amount of a particular amino acid (g/100 g protein) of the concentrate is within ±10%, preferably ±6% of the amount of said amino acid of the protein (g/100 g protein) oilseeds before being processed. According to a particular object of the invention, the sunflower seed concentrate of the invention comprises a content of sulphur amino acids (i.e. cysteine and methionine) which ranges from 1% to 5% (w/w), preferably from 1.5% to 4% (w/w), and in particular from 2% to 3.6% (w/w) with respect of the total protein weight. According to a particular object of the invention, the sunflower seed concentrate of the invention comprises a lysine content which ranges from 2% to 5% (w/w), preferably from 2.5% to 4% (w/w), and in particular from 2.5% to 3.6% (w/w), e.g. around 3.2%, with respect to total protein weight.

According to a particularly preferred object of the invention the sunflower seed protein concentrate has an acceptable amount of chlorogenic acid. By “acceptable amount” it is meant that the concentrate, preferably as a powder, has a colour, which is considered neutral, such as white or off white, and does not look green or greenish to a human eye especially when the concentrate is mixed at 2% with water and then adjusted at pH 9. Any base can be used to adjust the pH, preferably NaOH. The specification of a visual test is provided in the Examples below.

According to another object of the invention the sunflower seed protein concentrate of the invention, which may be advantageously obtained or obtainable by the process of the present invention, comprises:
a protein content of at least 55% dry matter w/w, pref. 58% dry matter w/w (DM), preferably at least 60% dry matter w/w and especially at least 65%, and less than 80% dry matter w/w (N×6.25); and
a content of polyphenol compounds of less than 2% DM w/w, preferably equal or less than 1% dry matter w/w.

It is preferred that the concentrate of the invention, advantageously obtained or obtainable by the process of the present invention, comprises a fat content of less than 14% dry matter w/w, preferably less than 10% DM w/w, in particular less than 5% dry matter w/w, more particularly less than 3% dry matter w/w, even more particularly less than 2% dry matter w/w. Thus, a preferred concentrate of the invention comprises:
a protein content of at least 55% dry matter w/w, pref. 58% dry matter w/w (DM), preferably at least 60% dry matter w/w and especially at least 65%, and less than 80% dry matter w/w (N×6.25);
a content of polyphenol compounds of less than 2% DM w/w, preferably equal or less than 1% dry matter w/w; and
a fat content of less than 14% dry matter w/w, preferably less than 10% DM w/w, in particular less than 5% dry matter, more particularly less than 3% dry matter w/w, even more particularly less than 2% dry matter w/w.

It is also preferred that the sunflower seed protein concentrate, advantageously obtained or obtainable by the process of the present invention, has a water holding capacity (WHC) per gram of concentrate, of at least 3 g/g, preferably from 3.4 g/g to 7.0 g/g, in particular from 4.0 g/g to 6.5 g/g, more particularly from 4.8 g/g to 5.5 g/g of concentrate; the method for measuring the WHC being described in the Examples below.

A preferred concentrate of the invention comprises:
a protein content of at least 55% dry matter w/w, pref. 58% dry matter w/w (DM), preferably at least 60% dry matter w/w and especially at least 65%, and less than 80% dry matter w/w (N×6.25);
a content of polyphenol compounds of less than 2% DM w/w, preferably equal or less than 1% dry matter w/w;
a fat content of less than 14% dry matter w/w, preferably less than 10% DM w/w, in particular less than 5% dry matter w/w, more particularly less than 3% dry matter w/w, even more particularly less than 2% dry matter w/w; and
a water holding capacity (WHC) of at least 3 g/g, preferably from 3.4 g/g to 7.0 g/g, in particular from 4.0 g/g to 6.5 g/g, more particularly from 4.8 g/g to 5.5 g/g of concentrate.

It is further preferred that the protein concentrate, advantageously obtained or obtainable by the process of the present invention, has a minimum gelling concentration of 15% (w/w) protein content or less, preferably of 12% (w/w) protein content or less, more preferably of 10% or less and even more preferably of 6% or less protein content.

A preferred concentrate of the invention comprises:
a protein content of at least 55% dry matter w/w, pref. 58% dry matter w/w (DM), preferably at least 60% dry matter w/w and especially at least 65%, and less than 80% dry matter w/w (N×6.25);
a content of polyphenol compounds of less than 2% DM w/w, preferably equal or less than 1% dry matter w/w;
a fat content of less than 14% dry matter w/w, preferably less than 10% DM w/w, in particular less than 5% dry matter w/w, more particularly less than 3% dry matter w/w, even more particularly less than 2% dry matter w/w;
a water holding capacity (WHC) of at least 3 g/g, preferably from 3.4 g/g to 7.0 g/g, in particular from 4.0 g/g to 6.5 g/g, more particularly from 4.8 g/g to 5.5 g/g of concentrate; and
a minimum gelling concentration of 15% (w/w) protein content or less, preferably 12% (w/w) protein content or less, more preferably of 10% or less and even more preferably of 6% or less protein content.

It is also preferred that the sunflower seed protein concentrate, advantageously obtained or obtainable by the process of the present invention, has a gelling capacity measured by the Final G′ value (the elastic or storage modulus after thermal treatment) in Pa of at least 1000 Pa, preferably of at least 2000 Pa, in particular of at least 3000 Pa, more particularly of at least 4000 Pa; the method for measuring the Final G′ value being described in the Examples below.

A preferred concentrate of the invention comprises:
a protein content of at least 55% dry matter w/w, pref. 58% dry matter w/w (DM), preferably at least 60% dry matter w/w and especially at least 65%, and less than 80% dry matter w/w (N×6.25);
a content of polyphenol compounds of less than 2% DM w/w, preferably equal or less than 1% dry matter w/w;
a fat content of less than 14% dry matter w/w, preferably less than 10% DM w/w, in particular less than 5% dry matter w/w, more particularly less than 3% dry matter w/w, even more particularly less than 2% dry matter w/w;
a water holding capacity (WHC) of at least 3 g/g, preferably from 3.4 g/g to 7.0 g/g, in particular from 4.0 g/g to 6.5 g/g, more particularly from 4.8 g/g to 5.5 g/g of concentrate;
a minimum gelling concentration of 15% (w/w) protein content or less, preferably 12% (w/w) protein content or less, more preferably of 10% or less and even more preferably of 6% or less protein content; and
a Final G′ value of at least 1000 Pa, preferably of at least 2000 Pa, in particular of at least 3000 Pa, more particularly of at least 4000 Pa.

It is preferred that the concentrate of the invention, advantageously obtained or obtainable by the process of the present invention, comprises a phytic acid content of less than 6% dry matter w/w, preferably less than 5.5% DM w/w, in particular less than 3.2% dry matter w/w, more particularly less than 2.7% dry matter w/w, even more particularly less than 1.5% dry matter w/w.; said content being determined as indicated below. Thus, a preferred concentrate of the invention comprises:
a protein content of at least 55% dry matter w/w, pref. 58% dry matter w/w (DM), preferably at least 60% dry matter w/w and especially at least 65%, and less than 80% dry matter w/w (N×6.25);
a content of polyphenol compounds of less than 2% DM w/w, preferably equal or less than 1% dry matter w/w;
a fat content of less than 14% dry matter w/w, preferably less than 10% DM w/w, in particular less than 5% dry matter w/w, more particularly less than 3% dry matter w/w, even more particularly less than 2% dry matter w/w;
a water holding capacity (WHC) of at least 3 g/g, preferably from 3.4 g/g to 7.0 g/g, in particular from 4.0 g/g to 6.5 g/g, more particularly from 4.8 g/g to 5.5 g/g of concentrate;
a minimum gelling concentration of 15% (w/w) protein content or less, preferably 12% (w/w) protein content or less, more preferably of 10% or less and even more preferably of 6% or less protein content;
a Final G′ value of at least 1000 Pa, preferably of at least 2000 Pa, in particular of at least 3000 Pa, more particularly of at least 4000 Pa.; and
a phytic acid content of less than 6% dry matter w/w, preferably less than 5.5% DM w/w, in particular less than 3.2% dry matter w/w, more particularly less than 2.7% dry matter w/w, even more particularly less than 1.5% dry matter w/w.

It is further preferred that the protein concentrate, advantageously obtained or obtainable by the process of the present invention, comprises a total sugar content of 1.5% (w/w)/DM or less, preferably of 1.0% (w/w)/DM and even preferably of 0.5% (w/w)/DM or less. It is also particularly advantageous that the concentrate comprises less than 0.5% (w/w)/DM of alpha-galactosyl derivatives of glucose (such as raffinose, stachyose, and verbascose), and particularly less than 0.3% (w/w)/DM. A preferred concentrate of the invention comprises:
a protein content of at least 55% dry matter w/w, pref. 58% dry matter w/w (DM), preferably at least 60% dry matter w/w and especially at least 65%, and less than 80% dry matter w/w (N×6.25);
a content of polyphenol compounds of less than 2% DM w/w, preferably equal or less than 1% dry matter w/w;
a fat content of less than 14% dry matter w/w, preferably less than 10% DM w/w, in particular less than 5% dry matter w/w, more particularly less than 3% dry matter (w/w), even more particularly less than 2% dry matter w/w;
a water holding capacity (WHC) of at least 3 g/g, preferably from 3.4 g/g to 7.0 g/g, from 4.0 g/g to 6.5 g/g, more particularly in particular from 4.8 g/g to 5.5 g/g of concentrate;
a minimum gelling concentration of 15% (w/w) protein content or less, preferably 12% (w/w) protein content or less, more preferably of 10% or less and even more preferably of 6% or less protein content;
a Final G′ value of at least 1000 Pa, preferably of at least 2000 Pa, in particular of at least 3000 Pa, more particularly of at least 4000 Pa;
a phytic acid content of less than 6% dry matter w/w, preferably less than 5.5% DM w/w, in particular less than 3.2% dry matter w/w, more particularly less than 2.7% dry matter w/w, even more particularly less than 1.5% dry matter w/w; and
a total sugar content of 1.5% (w/w)/DM or less, preferably of 1.0% (w/w)/DM and even preferably of 0.5% (w/w)/DM or less.

Preferably, the sunflower seed protein concentrate, advantageously obtained or obtainable by the process of the present invention, comprises a total fibre content ranging from 20% to 40% DM w/w, preferably from 22% to 40% DM w/w, in particular from 25% to 30% DM w/w. A preferred concentrate of the invention comprises:
a protein content of at least 55% dry matter w/w, pref. 58% dry matter w/w (DM), preferably at least 60% dry matter w/w and especially at least 65%, and less than 80% dry matter w/w (N×6.25);
a content of polyphenol compounds of less than 2% DM w/w, preferably equal or less than 1% dry matter w/w;
a fat content of less than 14% dry matter w/w, preferably less than 10% DM w/w, in particular less than 5% dry matter w/w, more particularly less than 3% dry matter (w/w), even more particularly less than 2% dry matter w/w;
a water holding capacity (WHC) of at least 3 g/g, preferably from 3.4 g/g to 7.0 g/g, from 4.0 g/g to 6.5 g/g, more particularly in particular from 4.8 g/g to 5.5 g/g of concentrate;
a minimum gelling concentration of 15% (w/w) protein content or less, preferably 12% (w/w) protein content or less, more preferably of 10% or less and even more preferably of 6% or less protein content;
a Final G′ value of at least 1000 Pa, preferably of at least 2000 Pa, in particular of at least 3000 Pa, more particularly of at least 1000 Pa;
a phytic acid content of less than 6% dry matter w/w, preferably less than 5.5% DM w/w, in particular less than 3.2% dry matter w/w, more particularly less than 2.7% dry matter w/w, even more particularly less than 1.5% dry matter w/w;
a total sugar content of 1.5% (w/w)/DM or less, preferably of 1.0% (w/w)/DM and even preferably of 0.5% (w/w)/DM or less; and
a total fibre content ranging from 20% to 40% DM w/w, preferably from 22% to 40% DM w/w, in particular from 25% to 30% DM w/w.

Preferably, the sunflower seed protein concentrate, advantageously obtained or obtainable by the process of the present invention, comprises a cellulose content ranging from 5% to 15% DM w/w, preferably from 8% to 12% DM w/w, in particular from 7% to 11% DM w/w.

A preferred concentrate of the invention comprises:
a protein content of at least 55% dry matter w/w, pref. 58% dry matter w/w (DM), preferably at least 60% dry matter w/w and especially at least 65%, and less than 80% dry matter w/w (N×6.25);
a content of polyphenol compounds of less than 2% DM w/w, preferably equal or less than 1% dry matter w/w;
a fat content of less than 14% dry matter w/w, preferably less than 10% DM w/w, in particular less than 5% dry matter w/w, more particularly less than 3% dry matter (w/w), even more particularly less than 2% dry matter w/w;
a water holding capacity (WHC) of at least 3 g/g, preferably from 3.4 g/g to 7.0 g/g, from 4.0 g/g to 6.5 g/g, more particularly in particular from 4.8 g/g to 5.5 g/g per gram of concentrate;
a minimum gelling concentration of 15% (w/w) protein content or less, preferably 12% (w/w) protein content or less, more preferably of 10% or less and even more preferably of 6% or less protein content;
a Final G′ value of at least 100 Pa, preferably of at least 2000 Pa, in particular of at least 3000 Pa, more particularly of at least 4000 Pa
a phytic acid content of less than 6.0% dry matter w/w, preferably less than 5.5% DM w/w, in particular less than 3.2% dry matter w/w, more particularly less than 2.7% dry matter w/w, even more particularly less than 1.5% dry matter w/w;
a total sugar content of 1.5% (w/w)/DM or less, preferably of 1.0% (w/w)/DM and even preferably of 0.5% (w/w)/DM or less;
a total fibre content ranging from 20% to 40% DM w/w, preferably from 22% to 40% DM w/w, in particular from 25% to 30% DM w/w; and
a cellulose content ranging from 5% to 15% DM w/w, preferably from 8% to 12% DM w/w, in particular from 7% to 11% DM w/w.

It is further preferred that the protein concentrate of the invention, advantageously obtained or obtainable by the process of the present invention, comprises a maximum total phosphorus content ranging from 1 to 2% DM (w/w), the method for measuring the amount of phosphorus being described in the Examples below. This is particularly preferred if phosphoric acid is used in the process of manufacturing the concentrate.

Preferably, the sunflower seed protein concentrate, advantageously obtained or obtainable by the process of the present invention, has a good emulsifying capacity. It may range, per gram of concentrate from 100 to 500 g of sunflower oil, in particular from to 125 to 300 g of sunflower oil, in particular from 140 to 250 g of sunflower oil (such as about 155 g of sunflower oil) per g of protein concentrate; the method for measuring the emulsifying capacity being described in the Examples below.

A preferred concentrate of the invention comprises:
a protein content of at least 55% dry matter w/w, pref. 58% dry matter w/w (DM), preferably at least 60% dry matter w/w and especially at least 65%, and less than 80% dry matter w/w (N×6.25);
a content of polyphenol compounds of less than 2% DM w/w, preferably equal or less than 1% dry matter w/w;
a fat content of less than 14% dry matter w/w, preferably less than 10% DM w/w, in particular less than 5% dry matter w/w, more particularly less than 3% dry matter (w/w), even more particularly less than 2% dry matter w/w;
a water holding capacity (WHC) of at least 3 g/g, preferably from 3.4 g/g to 7.0 g/g, from 4.0 g/g to 6.5 g/g, more particularly in particular from 4.8 g/g to 5.5 g/g per gram of concentrate;
a minimum gelling concentration of 15% (w/w) protein content or less, preferably 12% (w/w) protein content or less, more preferably of 10% or less and even more preferably of 6% or less protein content;
a Final G′ value of at least 1000 Pa, preferably of at least 2000 Pa, in particular of at least 3000 Pa, more particularly of at least 4000 Pa.
a phytic acid content of less than 6.0% dry matter w/w, preferably less than 5.5% DM w/w, in particular less than 3.2% dry matter w/w, more particularly less than 2.7% dry matter w/w, even more particularly less than 1.5% dry matter w/w;
a total sugar content of 1.5% (w/w)/DM or less, preferably of 1.0% (w/w)/DM and even preferably of 0.5% (w/w)/DM or less;
a total fibre content ranging from 20% to 40% DM w/w, preferably from 22% to 40% DM w/w, in particular from 25% to 30% DM w/w;
a cellulose content ranging from 5% to 15% DM w/w, preferably from 8% to 12% DM w/w, in particular from 7% to 11% DM w/w; and
an emulsifying capacity ranging from 100 to 500 g of sunflower oil, in particular from to 125 to 300 g of sunflower oil, in particular from 140 to 250 g of sunflower oil (such as about 155 g of sunflower oil) per gram of concentrate.

Preferably, the sunflower seed protein concentrate, advantageously obtained or obtainable by the process of the present invention, may be insoluble, that is has a protein solubility of more than 10% and less than 45%, in an aqueous solution at a pH ranging from 7 to 10, preferably more than 10% and less than 50%, in particular less than 40%, in an aqueous solution at a pH ranging from 7 to 8; the solubility being measured by the standard method described in the Examples (see infra).

A preferred concentrate of the invention comprises:
a protein content of at least 55% dry matter w/w, pref. 58% dry matter w/w (DM), preferably at least 60% dry matter w/w and especially at least 65%, and less than 80% dry matter w/w (N×6.25);
a content of polyphenol compounds of less than 2% DM w/w, preferably equal or less than 1% dry matter w/w;
a fat content of less than 14% dry matter w/w, preferably less than 10% DM w/w, in particular less than 5% dry matter w/w, more particularly less than 3% dry matter (w/w), even more particularly less than 2% dry matter w/w;
a water holding capacity (WHC) of at least 3 g/g, preferably from 3.4 g/g to 7.0 g/g, from 4.0 g/g to 6.5 g/g, more particularly in particular from 4.8 g/g to 5.5 g/g per gram of concentrate;
a minimum gelling concentration of 15% (w/w) protein content or less, preferably 12% (w/w) protein content or less, more preferably of 10% or less and even more preferably of 6% or less protein content;
a Final G′ value of at least 1000 Pa, preferably of at least 2000 Pa, in particular of at least 3000 Pa, more particularly of at least 4000 Pa.
a phytic acid content of less than 6.0% dry matter w/w, preferably less than 5.5% DM w/w, in particular less than 3.2% dry matter w/w, more particularly less than 2.7% dry matter w/w, even more particularly less than 1.5% dry matter w/w;
a total sugar content of 1.5% (w/w)/DM or less, preferably of 1.0% (w/w)/DM and even preferably of 0.5% (w/w)/DM or less;
a total fibre content ranging from 20% to 40% DM w/w, preferably from 22% to 40% DM w/w, in particular from 25% to 30% DM w/w, even more particularly less than 2% dry matter w/w;
a cellulose content ranging from 5% to 15% DM w/w, preferably from 8% to 12% DM w/w, in particular from 7% to 11% DM w/w;
an emulsifying capacity ranging from 100 to 500 g of sunflower oil, in particular from to 125 to 300 g of sunflower oil, in particular from 140 to 250 g of sunflower oil (such as about 155 g of sunflower oil) per gram of concentrate; and
a protein solubility of more than 10% and less than 45%, in an aqueous solution at a pH ranging from 7 to 10, preferably more than 10% and less than 50%, in particular less than 40% in an aqueous solution at a pH ranging from 7 to 8.

Preferably, the oilseed protein concentrate, advantageously obtained or obtainable by the process of the present invention, is a powder made of particles. This powder may have a D50 (μm) average particle size ranging from 25 μm and 200 μm, preferably between 25 μm and 50 μm, more preferably between 30 μm and 40 μm; and/or a D90 (μm) average particle size ranging from 100 μm and 500 μm, preferably between 140 μm and 400 μm, more preferably between 170 μm and 390 μm.

As mentioned above it was found that a protein concentrate having a D90 (μm) average particle size superior to 80 μm and preferably ranging from 80 μm to 150 μm, preferably from 90 μm and 120 μm, more preferably from 90 μm and 110 μm (e.g. around 100 μm), have particularly good organoleptic properties and a good mouthfeel.

A preferred concentrate of the invention comprises:
a protein content of at least 55% dry matter w/w, pref. 58% dry matter w/w (DM), preferably at least 60% dry matter w/w and especially at least 65%, and less than 80% dry matter w/w (N×6.25);
a content of polyphenol compounds of less than 2% DM w/w, preferably equal or less than 1% dry matter w/w;
a fat content of less than 14% dry matter w/w, preferably less than 10% DM w/w, in particular less than 5% dry matter w/w, more particularly less than 3% dry matter w/w, even more particularly less than 2% dry matter w/w;
a water holding capacity (WHC) of at least 3 g/g, preferably from 3.4 g/g to 7.0 g/g, from 4.0 g/g to 6.5 g/g, more particularly in particular from 4.8 g/g to 5.5 g/g of concentrate;
a minimum gelling concentration of 15% (w/w) protein content or less, preferably 12% (w/w) protein content or less, more preferably of 10% or less and even more preferably of 6% or less protein content;
a Final G′ value of at least 1000 Pa, preferably of at least 2000 Pa, in particular of at least 3000 Pa, more particularly of at least 4000 Pa;
a phytic acid content of less than 6.0% dry matter w/w, preferably less than 5.5% DM w/w, in particular less than 3.2% dry matter w/w, more particularly less than 2.7% dry matter w/w, even more particularly less than 1.5% dry matter w/w;
a total sugar content of 1.5% (w/w)/DM or less, preferably of 1.0% (w/w)/DM and even preferably of 0.5% (w/w)/DM or less;
a total fibre content ranging from 20% to 40% DM w/w, preferably from 22% to 40% DM w/w, in particular from 25% to 30% DM w/w;
a cellulose content ranging from 5% to 15% DM w/w, preferably from 8% to 12% DM w/w, in particular from 7% to 11% DM w/w;
an emulsifying capacity ranging from 100 to 500 g of sunflower oil, in particular from to 125 to 300 g of sunflower oil, in particular from 140 to 250 g of sunflower oil (such as about 155 ml of sunflower oil) per gram of concentrate;
a protein solubility of more than 10% and less than 45%, in an aqueous solution at a pH ranging from 7 to 10, preferably more than 10% and less than 50%, in particular less than 40% in an aqueous solution at a pH ranging from 7 to 8; and
have a D50 (μm) average particle size ranging from 25 μm and 200 μm, preferably between 25 μm and 50 μm, more preferably between 30 μm and 40 μm; and/or
having a D90 (μm) average particle size superior to 80 μm and preferably ranging from 80 μm to 150 μm, preferably from 90 μm and 120 μm, more preferably from 90 μm and 110 μm (e.g. around 100 μm).

It is also preferred that the concentrate of the invention contains little or no trace of non-polar organic solvent such as hexane and/or little or no trace of aprotic solvents.

The sunflower seed, the pressed sunflower seed (i.e., sunflower press cake), and more generally the product obtained according to the process of the invention, is not treated with a non-polar solvent and in particular is not treated with an alkane, and more particularly with hexane. Thus, the product obtained from the method of the invention is not contacted with such a solvent at any time during the process and the process does therefore not include the use of such a compound or compounds. Hence a sunflower protein concentrate of the invention is advantageously “hexane-free”, that is to say that it has less than 10 mg/kg, advantageously less than 5 mg/Kg and more preferably virtually no residual and/or trace amount of hexane (e.g. less than 1 mg/Kg). This quantification can also be applied to other solvents, such as non-polar or aprotic solvents.

It is further preferred that the concentrate of the invention contains no additive, and/or be constituted of at least 95% (w/w), preferably of at least 98% (w/w) of organic matter originating from the oilseed.

As mentioned above the concentrate of the invention is advantageously a powder and preferably a powder of a white, whitish or off white colour. An embodiment of the invention is therefore that the sunflower protein concentrate of the invention is a powder having a L* value ranging from 81 to 100, preferably from 84 to 100, more preferably from 86 to 100 and even more preferably from 87 to 100. The concentrate may have an a* value ranging from −2.0 to +2.0, preferably from −1.0 to +1.0 and even more preferably from −0.7 to +0.7. The concentrate may advantageously have a b* value may advantageously range from 0 to 20; preferably from 0 to 15, more preferably from 0 to 12.

Measurement of CIE 1976 parameters, or coordinates, L*, a* and b*, defines a position in the CIELAB colour space and allows to express the colour of a material and compare it to others. Lightness (L) relates to the light or dark aspect of a colour, wherein the lower the L-value, the darker the powder will appear. The a* value defines a position between green and red (where negative values indicate green and positive values indicate red) and the b* value its position between yellow and blue (where negative values indicate blue and positive values indicate yellow). In this specification the CIELAB (1976) colorspace is the one used to define the colour of the product of the invention.

The spectral colour is the result of the source of light and the reflecting surface. For a good reproducible measurement of the colour, standard conditions have to be met when carrying the measurement. These standard conditions are described herein below. The colour values recited herein are approximate in the sense that colour measurements may vary from spectrophotometer-to-spectrophotometer, typically in the range of +/−0.5 for L*, a*and b* values. The spectrophotometer used is a colorimeter CR-400/410 from Minolta.

### Uses and Methods

The sunflower seed protein concentrate according to the invention can be used in the food industry or feed industry, in particular for preparing a food product. In particular these food products can be related to bakery and cereals (ex. bread, biscuits, snack, cereals, and nutritional bars).

As the sunflower seed protein concentrate above described has a high water holding (absorption) capacity and/or structuring properties with heat treatment it is particularly well suited to be used as an ingredient (e.g., a structuring agent) for preparing meat based products (such as nuggets, knacks, ham or burgers) as well as meat (partial or total) substitutes in particular as meat alternatives or meat analogues (100% vegetarian products) (cf. Kyriakopoulou et al., 2019).

The invention also provides a process of making a foodstuff, a beverage or a food supplement, by adding and/or mixing any one of a sunflower seed protein concentrate above described, or a mixture thereof, to other ingredients.

Another object of the invention is the use of any one of a sunflower seed protein concentrate above described, or a mixture thereof, as a biofuel or bio-material or bio-composite, e.g. building materials.

Another object of the invention is the use of an oilseed protein concentrate above described, or a mixture thereof, as an animal feed (e.g. aquafeed) or a food or a dietary supplement or additive for animal and/or human consumption. In particular, the concentrate of the invention may comprise a high methionine content which is an essential amino acid for fish.

Foregoing and other objects and advantages of the invention will become more apparent from the following detailed description, which refers to non-limiting examples illustrating the uses according to the invention.

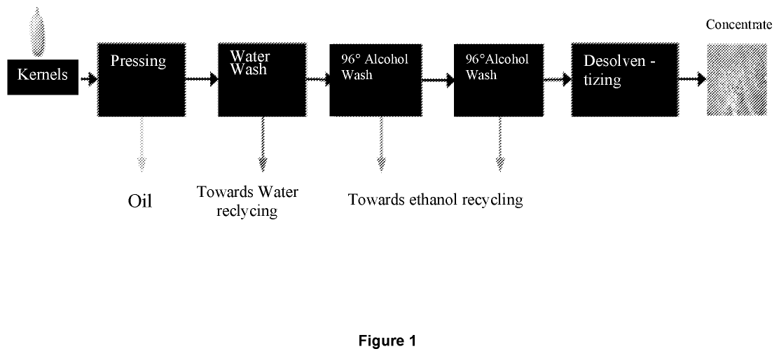

FIG. 1 is a schematic representation of a process according to the invention.

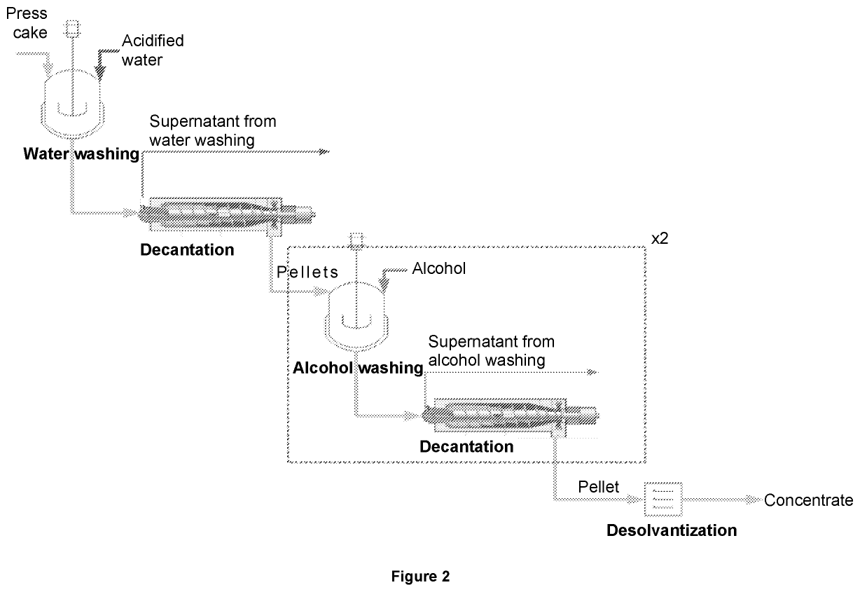

FIG. 2 is a schematic representation of the process of Example 1.

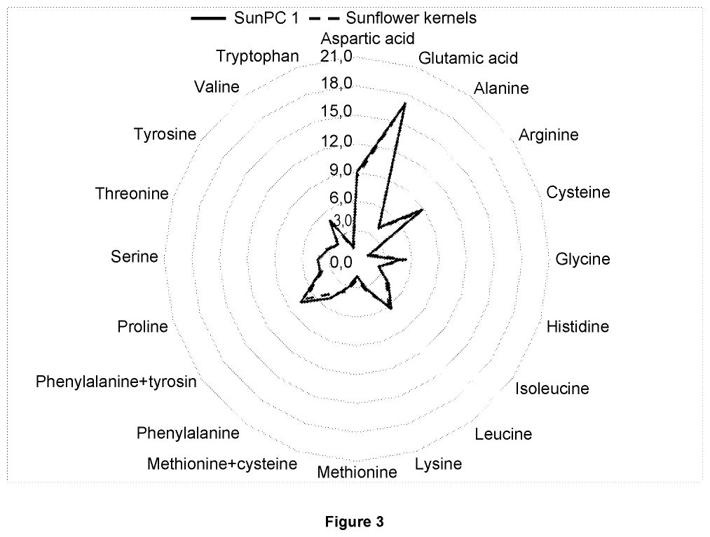

FIG. 3 show the amino acid composition in g/100 g of proteins within 1) the starting kernels and 2) SunPC1.

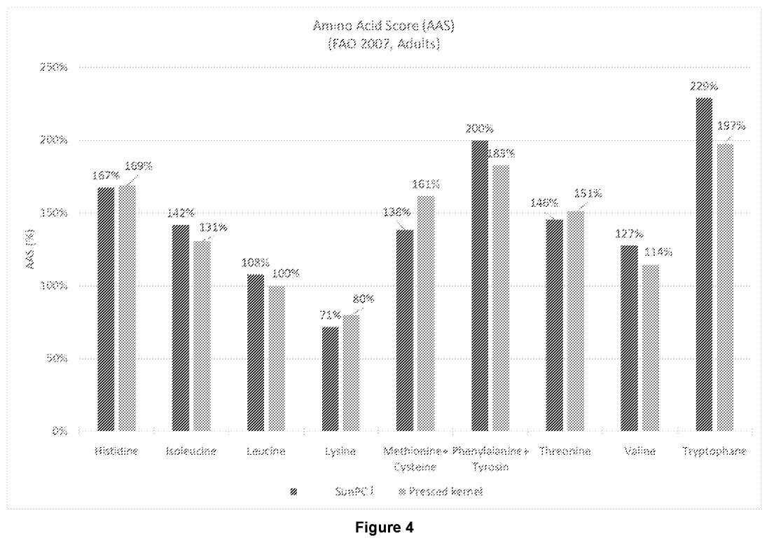

FIG. 4 shows the amino acid score of SunPC1 and of the starting kernels (based on Food and Agriculture Organization of the United Nations (FAO) recommendations 2007, for adults).

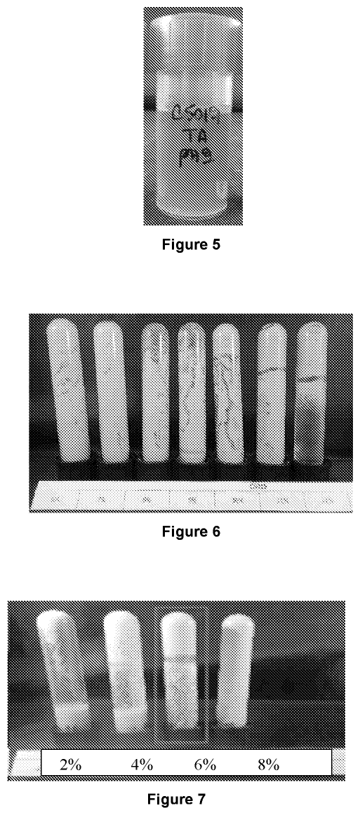

FIG. 5 is a picture of the supernatant obtained using the colorimetric test on the concentrate SunPC1. The apparent colour is dark yellow with a tinge of orange.

FIG. 6 shows the test tubes used to determine the minimum gelling concentration of SunPC1.

FIG. 7 shows the test tubes used to determine the minimum gelling concentration of SunPC2 (pH 7).

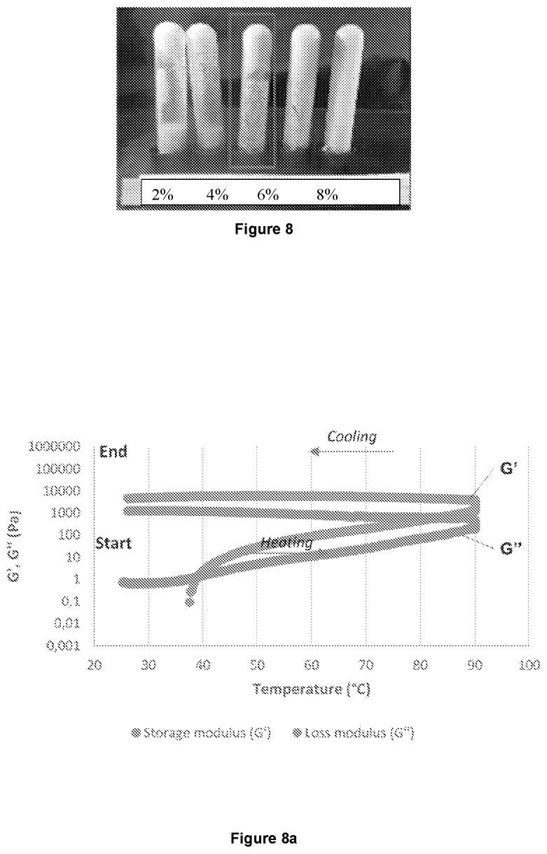

FIG. 8 shows the test tubes used to determine the minimum gelling concentration of SunPC2 (pH 6.5).

FIG. 8a shows the evolution of G′ and G″ of the concentrate of Example 1 during heating and cooling.

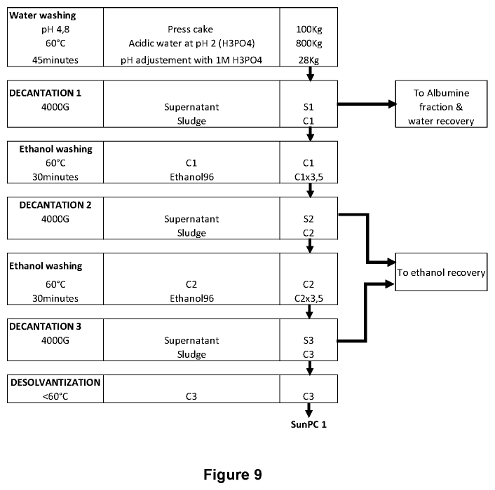

FIG. 9 shows a process diagram of the process of the Example 1.

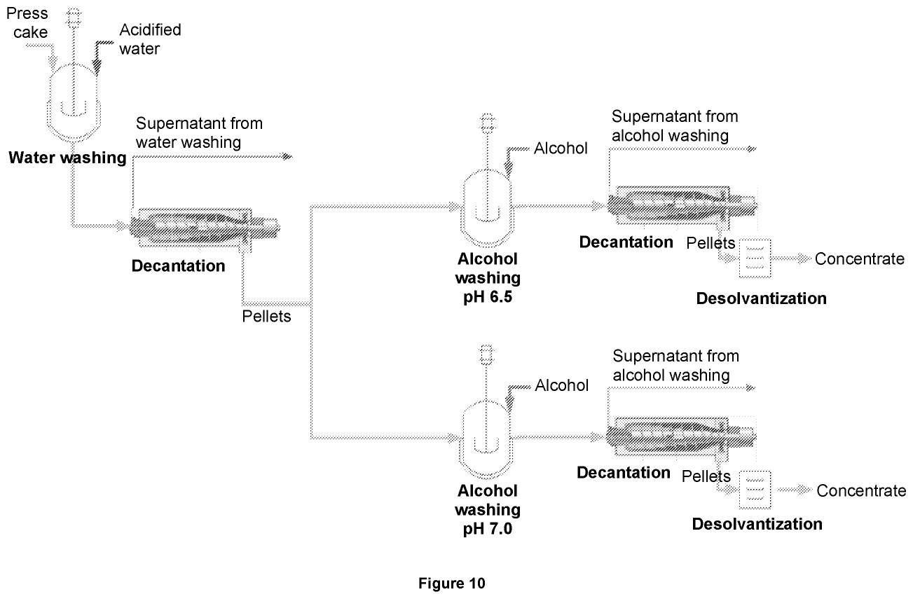

FIG. 10 is a schematic representation of the process of Example 2.

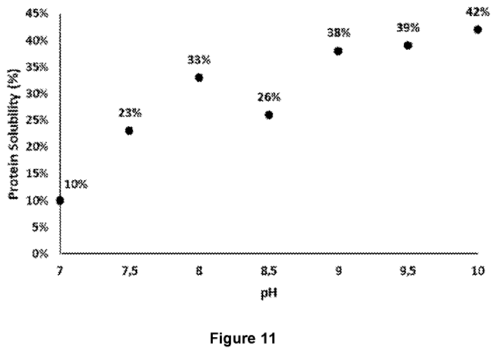

FIG. 11 show the evolution of protein solubility of Example 2 as a function of pH.

### EXAMPLES

The following examples were carried to exemplify the process of the invention.

The analytical methods used in these experiments were the following:
Dry matter: Total dry matter concentration in % (w/w) was determined using the French Standard NF EN ISO 6498 (2012)
Protein content: The protein content was determined by the Dumas/Kjeldahl method according to the French Standard (Norme AFNOR) NF EN ISO 16634-1. A conversion factor of 6.25 (N*6, 25) was used to determine the amount of protein (% (w/w)).
Ash content: The total ash content was determined according to the method described in the French Standard NF V18-101 (1977) entitled “Dosage des cendres brutes”/“Measurement of raw hashes”. The samples were preliminary grinded using a Retsch Grinder with a 1 mm grid.

The following changes were made to NF V18-101 (1977):
The NF V18-101 Standard recommends to first carbonising the test sample using a flame treatment or a progressive heating on a hot plate before it putting it in a muffle furnace at 550° C. for a period of three hours. The method used to measure the ash content in the example avoids this preliminary calcination step, by increasing the heating time in the muffle furnace at 550° C. from three (3) to thirteen (13) hours.
In the event that the sample is insufficiently calcined, the Standard NF V18-101 requires the ashes to be moistened with pure water, dried in a drying oven (about 1 hour), then heated for 1 hour in the muffle furnace. In the present case, it is recommended to increase the 1 hour heating of the dried sample in the muffle oven from 1 to 13 hours at 550° C. The resulting ash content is provided as a (w/w) percentage of the sample original weight.
Fat content: The fat content (% (w/w)) was determined according to the Standard NF ISO 6492-B (2011) entitled “Aliments des animaux—Determination de la teneur en matiere grasse/Animal feeding stuffs—Determination of fat content” which measure the fat content after carrying out a hydrolysis with 3N aqueous chlorohydric acid. The samples were preliminary grinded using a RETSCH Grinder ZM 20 to achieve an average size of 1 mm/using glass bead of 1 mm.

The following changes were made to NF ISO 6492-B (2011):
The mass of the sample being analysed was reduced to 0.8 g.
NF ISO 6492-B (2011) recommends the use of a Soxhlet extractor. Instead an automated system such as the one sold under Soxtec™ by FOSS (Denmark) was used.

Total polyphenols content: measured by the following colorimetric protocol:

### Reference:

0.15 g of gallic acid (from Riedel Haen, ref. 27645) mixed with 100 ml of water is further diluted in 900 mL of water (ratio 1/10). Then 50 mL vials containing 0.0 mL, 0.5 mL, 1 mL and 2 mL of this solution are further diluted with 30 mL of water. A 1 mL aliquot from each vial is poured in a 50 ml vial and 30 ml of water are added. Then, 2.5 ml of Folin-Ciocalteu reagent (2N Sigma ref. F9252) is added to the vial and the vial is agitated. 7.5 ml of a solution of sodium carbonate (20% (w:w) of anhydrous sodium carbonate) are then added. After 30 seconds, the mixture is agitated and then let to rest for 1H30 mn at room temperature. The total volume is then adjusted to 100 mL by adding more water to the vials. Absorbance of these solutions is measured at 765 nm using UV/VIS spectrophotometer against distilled water and a standard or calibration curve is obtained.

### Samples:

The samples are prepared by grinding each of the solid samples with a ball mill. The powder used has a maximum size of the particles of 1 mm. 1 g of this powder is weighted in a 100 mL vial. Close to 100 mL of a mixture of MeOH/water/acetone/HC(1N), having the relative proportion 40/38/20/2, (v:v), is added to the sample. The vial's content is agitated for 1 h at 60° C. in a bain-marie. The total volume is then adjusted to 100 mL by adding more solvent.

A 1 mL aliquot from each vial is poured in a 50 ml vial and 30 ml of water are added. Then, 2.5 ml of Folin-Ciocalteu reagent (2N Sigma ref. F9252) is added to the vial and the vial is agitated. 7.5 ml of a solution of sodium carbonate (20% (w:w) of anhydrous sodium carbonate) are then added. After 30 seconds, the mixture is agitated and then let to rest for 1H30 mn at room temperature. The total volume is then adjusted to 100 mL by adding more water to the vials. Absorbance of these solutions is measured at 765 nm using UV/VIS spectrophotometer against distilled water. The total phenolic content was read against the calibration curve and the results are expressed as micrograms per millilitre of gallic acid equivalents (μg/mL of GAE). The measures are duplicated.

Sugars content: The content of sugars (% (w/w)) was determined using the Luff Schoorl method as described in UE Regulation 152/2009.

Phosphorus content: The content of phosphorus (% (w/w)) was determined according to the French Standard NF ISO 6491(2011).

Soluble/insoluble fibres content: The content of soluble and the content of insoluble fibres (% (w/w) were determined using the Standard AOAC 991-43 (1995).

Total fibres content: measured according to the AOAC 991-43: 1995 standard.

Amino acids: The content of amino acids (% (w/w)) in a protein concentrate (amino acid profile) was determined according to the French Standard NF EN ISO 13903/04 (2005).

Colour assessment: The device used to carry out the colour measurement is a CR-400/410 chromameter (Minolta). The powder sample was placed in a Petri dish and flattened, then the chromameter was placed in contact with the product vertically to the sample and the measurement is made. There is no specific mass to be weighed, but a significant and homogeneous sample thickness is required throughout the Petri dish. The Petri dish was filled to a thickness of about 0.5 cm. The 3 coordinates L*, a*, b* (without unit) are read. The illuminant was D65, the number of measures taken n=1, no backlight was used and the observer angle selected was 0°.

The colorimeter consists of a sensor associated with filters and a microprocessor. The detection system is composed of three interference filters associated with a sensor.

Colour analysis of powder was evaluated with a colorimeter. Results are expressed by 3 parameters L*, a* and b* according to the CIELab (1976) colour space
L * (lightness), which ranges from 0 (black) to 100 (white)
a * which ranges from −300 (green) axis to 299 (red).
b * which ranges from −300 (blue) axis to 299 (yellow).

Protein solubility: The protein solubility of Examples 1 and 2 were tested on stirred (500 rpm for 15 mins) protein suspensions at 2% (w/w) dry matter content at selected pH. pH was adjusted using NaOH or HCl at 1M and the suspensions stirred at 500 rpm for 30 minutes. The protein solubility was estimated by the Kjeldahl method on the supernatant after centrifugation (15000 g, 10 min). The calculation of percentage of proteins solubility=Proteins in the supernatant %×100/proteins initially put in the solution.

Emulsifying capacity: The emulsifying capacity represents the amount of oil, such as sunflower oil, that the protein concentrate is able to emulsify. A solution at 1.5% (w/w) dry matter was prepared in water. After 1 h of solubilisation under agitation at 500 rpm, the protein solution was shaken at 6 000 rpm by an IKA shaker. Sunflower oil was continuously added in the proteins solution under stirring at 6000 rpm with a flow of 50 mL/min. The maximum oil capacity was evaluated by phase inversion visually and by conductimetry. The reference used for this test is sodium casein.

Water holding capacity: The water holding capacity was measured by adding samples in water at a concentration of 20 mg/ml of dry matter. Solutions were blended 1 hour under stirring. After centrifugation at 15000 g during 10 min, the water content of the pellet was measured and compared with the initial weight of materials. Results are expressed as the numbers of times that sample retain its weight in water.

Minimum gelling concentration: Minimum gelling concentration was measured by preparing solutions of protein concentrate in water starting from 2% (w/w) in test tubes (PR-18009) at pH 6. The protein content or the solid content is increased by 2% for each tube, usually 5 to 10 tubes are sufficient. After solubilization, solutions were heated 1 h in a water-bath at 85° C. and then cooled 2 h at 4° C. A solution was considered to have formed a gel if it behaved like a liquid before heating (i.e. free-flowing) and did not flow when test-tube was put upside-down after heating.

Gelling properties: Gelling capacity was measured on a DHR-2 rheometer (TA) with a 40 mm plate/plate geometry. The protein was mixed with water to obtain a 6% equivalent protein (N×6.25) solution. The pH of the solution is then adjusted at pH 7. A temperature ramp was applied to the sample: heating from 25 to 90° C. with a gradient of 2° C./min, stabilization without oscillation at 90° C. for 10 minutes, cooling from 90 to 25° C. with a gradient of 2.5° C./min. A strain of 0.1% was applied during the test. G′ (storage modulus) and G″ (loss modulus) were measured.

Phytic acid content: measured according to the method of Analytical Biochemistry Vol. 77:536-539 (1977).

### Example I: Production of a Sunflower Protein Concentrate According to the Invention (SunPC1)

Process steps to obtain a concentrate according to this embodiment of the invention are represented in FIG. 1.

### 1. Production of the Sunflower Press Cake

The starting material was oleic sunflower kernels (supplied by the company FLANQUART SAS, Z.I. B-Impasse du Plat Rio BP 5-62232 ANNEZIN-FRANCE).

The composition of the kernels (i.e. 100% dehulled sunflower seed) is given in Table 1, below. A press cake from sunflower kernels was produced with a MBU20 screw press (sold by the French Company OLEXA (Feuchy, FR). The temperature within the press was ranging from 60.8 to 71.2° C. 213 kg of press cake pellets having an oil content of 7.9 wt. %/dry matter (DM) were produced. The composition of the press cake is shown in Table 1 below.

TABLE 1
Composition of the sunflower kernels and the press cake

| Components in weight %* | Sunflower Kernels | Press cake |
|---|---|---|
| Moisture | 4.9 | 9.7 |
| Fat | 55.0 | 7.6 |
| Protein (% as is) | 24.5 | / |
| Protein (% dry matter) | 25.7 | / |
| Protein (% defatted dry matter) | 58.9 | / |
| Cellulose | 5.3 | / |
| Ash | 3.4 | / |

*over total weight except specified otherwise
Protein = N × 6.25

### 2. Washing Steps and Production of a Concentrate According to the Invention

The washing and concentration steps are represented in more details on FIGS. 2 and 9.

### 2.1 Water Washing Step

One hundred (100) kilograms of the sunflower press cake was added to a stirred 3000 L jacketed tank. The tank contained water acidified beforehand to pH 2 using phosphoric acid and preheated at 60° C. The press cake/water weight ratio used was 1/8. The pH of the mixture was then adjusted to 4.8 using 1 M phosphoric acid, and the temperature maintained between 55-60° C. At pH 4.8, the total weight of phosphoric acid solution added to adjust the pH was 28 Kg. At this pH, the mixture was stirred for 3 h and then separated by centrifugation using a pilot decanter (Z23 Atex, Flottweg). During decantation, the decanter parameters were adjusted as seen in Table 2 below to obtain a liquid fraction with less than 0.2 wt. % of solids when the input slurry contains 25 wt. % of solids. The feed rate of the decanter was set at 600 L/h. The diameter of the diaphragm (liquid phase separator) and the speed of the bowl were established between at 155-160 mm and 5600-5838 RPM, respectively. The differential speed between the bowl and the screw was adjusted during the decantation step.

TABLE 2

| | In process | | | Total |
|---|---|---|---|---|
| | samples | | Mean | weight (KG) |
| Solid/liquid | Input solid content | (%) | 25 | |
| separation 1 | Feed rate | (L/h) | 600 | |
| Z23 | Diameter | (mm) | 155-160 | |
| | Bowl speed | (RPM) | 5838-5600 | |
| | Liquid phase | (%) | 0.15 | |
| | solid content | | | |
| | Total liquid phase | (KG) | 752 | 29.55 |
| | Liquid phase | (%) | 3.93 | |
| | dry matter | | | |
| | Total solid phase | (KG) | 185 | 56.39 |
| | Solid phase | (%) | 30.48 | |
| | dry matter | | | |

After the decantation, 752 Kg of liquid phase and 185 Kg of solid phase were obtained. The solid fraction was used for the next step.

### 2.2 First Alcohol Washing Step

The solid fraction recovered from the previous decantation (185 Kg) was mixed with ethanol 96% preheated to 60° C. in the same tank. The weight ratio solids/96% ethanol used was 1/3.5, i.e. 647.5 Kg of ethanol 96% was used. The mixture was stirred for 30 minutes at constant temperature (55-60° C.) during 30 minutes and separated by centrifugation with the Z23 decanter. During decantation, the parameters were adjusted as seen in Table 3 below, to obtain a liquid fraction with less than 0.1 wt. % of solids when the input slurry contains 30 wt. % solids. The feed rate of the decanter was set at 600 L/h. The diameter of the diaphragm (liquid separator) were established between 165 and 155 mm and the rotation speed of the bowl between 5261 and 5673 RPM. The differential speed between the bowl and the screw was adjusted during decantation step.

TABLE 3

| | In process | | | Total |
|---|---|---|---|---|
| | samples | | Mean | weight (KG) |
| Solid/liquid | Input solid content | (%) | 30 | |
| separation 2 | Feed rate | (L/h) | 600 | |
| Z23 | Diameter | (mm) | 155-165 | |
| | Bowl speed | (RPM) | 5261-5673 | |
| | Liquid phase | (%) | <<0.1 | |
| | solid content | | | |
| | Total liquid phase | (KG) | 683 | 4.17 |
| | Uquid phase | (%) | 0.61 | |
| | dry matter | | | |
| | Total solid phase | (KG) | 134 | 53.02 |
| | Solid phase | (%) | 39.57 | |
| | dry matter | | | |

At the end of the decantation step, 683 Kg of liquid phase and 134 Kg of solid phase were obtained. The solid fraction was used for the next ethanol washing step.

### 2.3 Second Alcohol Washing Step

The solid fraction recovered from the previous decantation (134 Kg) was mixed with ethanol 96% preheated to 60° C. in the same tank. The weight ratio solids/96% ethanol used was 1/3.5, i.e. 469 Kg of ethanol 96%. The mixture was stirred for 30 minutes at constant temperature (55-60° C.) during 30 minutes and separated by centrifugation with the Z23 decanter. During decantation, the decanter parameters was adjusted as seen in Table 4 to obtain a liquid fraction with less than 0.5 wt. % of solids when the input slurry contains 30 wt. % of solids. The feed rate of the decanter was set at 600 L/h. The diameter of the diaphragm (liquid separator) were established between 165 mm and the rotation speed of the bowl between 5666 RPM. The differential speed between the bowl and the screw was adjusted during separation step.

TABLE 4

| | In process | | | Total |
|---|---|---|---|---|
| | samples | | Mean | weight (KG) |
| Solid/liquid | Input solid content | (%) | 35 | |
| separation 3 | Feed rate | (L/h) | 600 | |
| Z23 | Diameter | (mm) | 165 | |
| | Bowl speed | (RPM) | 5666 | |
| | Liquid phase | (%) | <<0.5 | |
| | solid content | | | |
| | Total liquid phase | (KG) | 478 | 1.72 |
| | Liquid phase | (%) | 0.36 | |
| | dry matter | | | |
| | Total solid phase | (KG) | 114 | 47.44 |
| | Solid phase | (%) | 41.61 | |
| | dry matter | | | |

At the end of the decantation step, 478 Kg of liquid phase and 114 Kg of solid phase were obtained. The solid fraction was used for the desolventizing step.

### 2.4 Desolventizing Step

The total amount of solid fraction obtained in the previous step was desolventized by using a double cone vacuum dryer. 4 batches were made to dry the entire product as shown in Table 5. The drying temperature is kept below 60° C. and the pressure reduced to avoid degrading the product.

TABLE 5

| | | | |
|---|---|---|---|
| Desolventizing step | Input wet solid | (KG) | 113.0 |
| | Output dry solid | (KG) | 50.4 |
| | Dry matter dry solid | (%) | 86.9 |
| | Duration | (h) | 19 |

After the drying step, around 50 Kg of sunflower protein concentrate (SunPC1) was obtained. The mean dry matter content of the total concentrate was 86.9 wt. %.

### 2.5 Millinq

The SunPC1 obtained after desolventizing was milled by using a jet mill (Alpine 200 AFG, HOSOKAWA). The particles size before and after milling are shown in Table 6 below.

TABLE 6

| | D10 | D50 | D90 | D95 | D99 |
|---|---|---|---|---|---|
| Before | 12.68 μm | 56.10 μm | 371.30 μm | 508.02 μm | 734.11 μm |
| milling | | | | | |
| After | 8.07 μm | 35.40 μm | 180.26 μm | 286.47 μm | 470.32 μm |
| milling | | | | | |

### 3. Physical Properties and Chemical Composition of the Concentrate (SunPC1)

### 3.1 Composition of SunPC1

The composition of the SunPC1 is shown in Table 7 below. The protein purity of the concentrate is 67.8 wt. %/DM against 25.7 wt. %/DM in the kernels (100% dehulled sunflower seed). This corresponds to an absolute increase in the protein/DM rate of 42.1 wt. %. This enrichment is due to the significant elimination of fat and other compounds achieve by the process of the invention.

TABLE 7
Composition of SunPC1111

| | SunPC1 | |
|---|---|---|
| Protein/DM | 67.8 | wt. % |
| Ash/DM | 6.8 | wt. % |
| Fat/DM | 1.5 | wt. % |
| Cellulose/DM Wendee Gravimetric NF V 03-040 | 8.1 | wt. % |
| Neutral Detergent Fibre- NDF (% DM) - Acid hydrolysis | 16.2 | wt. % |
| NF V 18-122 (2013)/DM | | |
| Acid Detergent Fibre - ADF (% DM) - Acid Hydrolysis | 10.2 | wt. % |
| NF V 18-122 (2013) | | |
| Acid Detergent Lignin - ADL (% DM) - Meth. Acid | 0.8 | wt. % |
| hydrolysis NF V18-122 (2013) | | |
| Soluble fibres/DM | 24.7 | wt. % |
| Insoluble fibres/DM | 2.3 | wt. % |
| Total fibres/DM | 27 | wt. % |
| Total sugars/DM | 0.9 | wt. % |
| Sodium/DM | 0.0 | wt. % |
| Phosphorus/DM | 1.7 | wt. % |
| Total phenolic compounds/DM | 0.68 | wt. % |
| Raffinose/DM | <0.1 | wt. % |
| Stachyose/DM | <0.1 | wt. % |
| Verbascose/DM | <0.1 | wt. % |

### Test for Acceptable Elimination of Chlorogenic Acid.

### Method for Identifying the Presence of Chlorogenic Acid by a Visual Colorimetric Test

A mass of 1 g of solid is introduced into a beaker and then 50 g of alkaline water at pH 9 is added and the pH of the suspension adjusted to pH 9. After 1 h at room temperature, the pH is again checked and readjusted if necessary then the suspension is centrifuged at 4000 g for 10 minutes or filtered with Whatman filter paper. The presence of chlorogenic acid is revealed by the green colour of the supernatant or of the filtrate. The absence of colour indicates a potentially sufficient elimination of chlorogenic acid for culinary use. The absence of green coloration during the colorimetric test of chlorogenic acid at pH 9 indicates sufficient elimination of these molecules.

The sunflower concentrate SunPC1 was tested according to the above method and the resulting filtrate/supernatant shown in FIG. 5 had an dark yellow, light orange colour without any greenish hue.

### 3.2 Nutritional Properties of SunPC1

The amino acid profile (g/100 g protein) of the SunPC1 is compared (FIG. 3) with the starting kernels. There is very little variation between the kernels and SunPC1 with the exception of a slightly less glutamic acid content in the kernels.

SunPC1 has a lower lysine content compared to soybean or pea seed proteins which are well studied in the literature (cf. Fevrier (1996)). The process of the invention does not degrade lysine content. Lysine is the (only) limiting amino acid in the kernel and consequently in SunPC1 as it lysine amino acid content is only 71% (w/w) of the content recommended by the FAO 2007). However, as shown in FIG. 4, the high content of sulfur amino acid (Amino acid score of “Methionine+Cysteine” 130%) in SunPC1 is remarkable, and constitutes a good source of complementarity with pulses, such as peas, which are deficient in these amino acids.

In conclusion, SunPC1 constitutes a good source of protein intake.

### 3.3 Functional Properties of SunPC1

The functional properties of SunPC1 are reported in Table 8 below. Water Holding Capacity: 1 g of concentrate (i.e. solids) can retain 4.7 g of water. It has good emulsifying properties: 1.51 g of concentrate (equivalent to about 1 g protein) can emulsify 157.6 g of sunflower oil.

TABLE 8

| | | | SunPC1 |
|---|---|---|---|
| Water holding capacity (g of water/ | | | 4.7 |
| g of solids) | | | |
| Emulsifying capacity (g of | | | 157.6 |
| sunflower oil/1 g of solids) | | | |
| | Minimum gelling | % proteins | 12% |
| | concentration* | Final G′, | 4664 |
| | Gelling properties | after thermal | |
| | | treatment | |
| | | (Pa) | |

*See FIG. 6

The rheological properties were tested by measuring the G′ (elastic or storage modulus) and G″ (viscous or loss modulus) values. These values are represented—in FIG. 8a. It was observed a progressive increase in G′ (elastic or storage modulus) during the heating step, especially from 40° C. This increase from this low temperature may be due to water absorption with time rather than protein gelation. The G′ value after heating and then cooling of the samples (gel strength) was quite high: 4664 Pa.

### 3.4 Colour of the Powder (SunPC1)

The colour of the powder was measured using a chromameter Konica Minolta CR400 CR410 as described above. The scale used was the integrated colour space CIELab (L*, a*, b*). The colour of the powder is a white. The standardised colour analysis of the SunPC1 is shown below:
L*: 89.25
a*: 0.07
b*: 9.5

### 3.5 Protein Solubility (Nitrogen Solubility Index)—Comparative Data

Although the method described above to measure solubility according to the invention is now fairly standard, methods used in the past to assess protein solubility vary and provide non comparable results. Thus, protocols used in the prior art, when available, had been replicated in order to compare to the protocol used in these examples. The results of these measurements are shown in Table 8a below:

TABLE 8a

| SunPC1 | pH 2 | pH 3 | pH 4 | pH 5 | pH 6 | pH 7 | pH 8 | pH 9 | pH 10 |
|---|---|---|---|---|---|---|---|---|---|
| Standard method (see | n.d. | n.d. | n.d. | 8% | 10% | 6% | 12% | n.d. | n.d. |
| above) | | | | | | | | | |
| Rahma 1979 Water | 14% | n.d. | 10% | n.d. | 5% | n.d. | 14% | n.d. | 36% |
| Rahma 1979 1M NaCl | 12% | n.d. | 12% | n.d. | 14% | n.d. | 16% | n.d. | 17% |
| Saeed 1985 | 18% | 6% | 3% | 4% | 3% | 4% | 9% | 20% | 39% |
| Rahma 1981 | n.d. | n.d. | n.d. | n.d. | n.d. | 4% | n.d. | n.d. | n.d. |

Protein Solubility Protocol from Rahma et al., 1979

The protein solubility was tested on protein suspensions at 10% protein content (2 g sample in 20 mL of solvent) at 5 points of pHs: 2, 4, 6, 8 and 10. Two solvents were used: distilled water or 1M NaCl. The pH was adjusted using 0.5M HCl or 0.2M NaOH and the solution was left to stir for 1 h at 30° C. The protein solubility was estimated by Kjeldahl method on the supernatant after centrifugation (4000 rpm for 20 minutes).

Protein solubility protocol from Saeed et al., 1988 The protein solubility was tested on protein suspensions at 2% protein content at pH 2, 3, 4, 5, 6, 7, 8, 9, 10. The pH was adjusted using 0.5M HCl or 0.2M NaOH and the solution was left to stir for 1 h. Clear supernatants were obtained by centrifugation for 30 min at 6000 g. The clear supernatant was filtered through Whatman filter paper (N0 3) and the filtrate analysed for nitrogen.

Protein Solubility Protocol from Rahma et al., 1981.

The method used in this publication is the AOAC method from 1975: this method could not be located, therefore, method AOCS (revised 2017) was used. This protocol was as follows: Weigh 5 g of sample into 400 mL beaker. Measure 200 mL of distilled water at 30° C. Add a small proportion of the water at a time and disperse it thoroughly with a stirring rod (400 rpm for 5 min to have a visually homogeneous dispersion, formation of a small vortex). Stir the remaining of the water, using the last of it to wash off the stirring rod. Add 0.1 M NaOH to adjust to pH 7. Stir the mixture at 120 rpm with the mechanical stirrer for 120 min at 30° C. with the beaker immersed in the 30° C. water bath No antifoam added (visually not required). Dilute to mark with distilled water and mix the contents of the flask thoroughly. Allow to stand for 5 minutes and decant off about 40 mL into a 50 mL centrifuge tube. Centrifuge 10 min at 1500 rpm at 20° C. Filter using of a filter+glass microfibre. Collect the clear filtrate in a 100 mL beaker. Pipet 25 mL of the clear liquid into a pot and measure the nitrogen content by the Kjeldahl method.

The calculation of percentage of proteins solubility (or Nitrogen Solubility Index)=Proteins in the supernatant (clear liquid) %×100/proteins initially put in the solution.

### Example 2: Production of a Sunflower Protein Concentrates According to the Invention with a Single Alcohol Wash

Two sunflower protein concentrates according to the invention were produced at a small-pilot scale from 20 kg pressed sunflower kernels (fully dehulled sunflower seeds). The process steps carried out are shown on the production diagram of FIG. 10 for both concentrates.

After the step of washing with acidic water, the washed press cake was divided into two batches. The pH of the solids/ethanol mixture was adjusted to 6.5 with 1M NaOH for the first batch, for the second batch the pH was adjusted to 7.0, also using 1M NaOH.

The combination of a single acidic wash with a single alcohol wash was shown to be effective to dispose of the chlorogenic acid.

### 1. Production of Sunflower Press Cake

Press cake from sunflower kernels (fully dehulled sunflower seeds) was produced with the MBU20 screw press (Olexa, France). At the start, the speed of rotation of the press was adjusted to 50 Hz without tightening the cone. Then, as the press start to heat due to the pressing of the first kilograms of kernels, the rotation speed was gradually reduced to 3.8 Hz and the cone was gradually tightened. This tightening made it possible to form a plug at the end of the press which blocked the outlet of the press cake. Then, a slight loosening of the cone allowed the passage of some of the pressed kernels and the formation of scales. The speed of rotation was then stabilized at 10 Hz. A drip of water was placed at the feed hopper. The press cake output was 3.0 kg/h. A similar oil flow output was observed. The temperature observed in the press cage varied between 65° C. and 67° C.

After pressing, 26 kg of sunflower press cake were produced. The chemical composition of this press cake is shown in the table 9 below:

TABLE 9

| Components | |
|---|---|
| in weight %* | Press cake |
| Moisture | 9.5% |
| Fat content (% as is) | 10.9% |
| Protein (N × 6.25) (% as is) | 47.7% |
| Protein (% dry matter) | 53% |
| Protein (% defatted dry matter) | 59.9% |
| Ash content (% as is) | 6.5% |

*over total weight except specified otherwise

Protein=N×6.25

Compared to the press cake obtained in the Example 1, the residual fat content is relatively higher (+38%).

### 2. Water Washing Step

Twenty (20) kilograms of the sunflower press cake produced previously were added to a stirred 250 L jacketed agitated reactor, containing water preheated at 60° C. The water was acidified beforehand to pH 2 using phosphoric acid. The press cake/water weight ratio used was 1/8. The pH of the mixture was then adjusted to 4.8 using 1 M phosphoric acid or 1 M sodium hydroxide, and the temperature maintained between 55-60° C. At pH 4.8, the mixture was stirred for 45 minutes and then separated by centrifugation at 4000 g using a pilot decanter (Z23, Flottweg). The decanter parameters are shown below:
Decanter Z23, Flottweg
Rotation speed: 4500 g
Impeller: 140 mm
Differential speed: 15%
Back pressure: 0 bar

The solid fraction recovered after decantation was used for the single ethanol washing step.

### 3. Ethanol Washing Step and Concentrate Isolation

The solid fraction recovered after the acidic water washing step was divided into two parts to carry out a single ethanol wash at either pH 6.5 or pH 7.0.

### 3.1. 96% Ethanol Washing at pH 6.5

The solid fraction recovered from the decantation was mixed with ethanol 96% preheated to 60° C. The ratio solids: 96% ethanol used is 1/3.5 in weight. The pH of the mixture was adjusted to 6.5 using 1M NaOH. The mixture was stirred for 30 minutes at constant temperature (about 55-60° C.). After 30 minutes, the mixture was separated by centrifugation at 4000 g (MD80 Lemitec). The parameters of the decanter centrifuge are given below:
Decanter Lemitec,
Rotation speed: 4000 g,
Diaphragm: 12 mm,
Differential speed 15%.

### 3.2. 96% Ethanol Washing at pH 7.0

For this test, the same parameters as the ones for the previous example (see § 3.1) were applied with the exception of the pH which was adjusted to 7.0 instead of 6.5.

The two solid fractions recovered after solid/liquid separation were dried separately in a ventilated oven at 60° C. and for 10 h and then micronized using the Impact Mill from Hosokawa (ZPS 100, Hosokawa-Alpine) to obtain a flour having D₅₀ of 37 μm (for the pH 6.5 test) and D₅₀ 43 μm (for the pH 7.0 test).

The physicochemical composition of the products obtained, SunPC2, is shown in table 10 below:

TABLE 10

| In wt. % | SunPC2 (pH 6.5) | SunPC2 (pH 7.0) |
|---|---|---|
| Dry matter | 96.4% | 92.6% |
| Protein/DM | 61.1 | 60.6 |
| Fat/DM | 9.8% | 11.4% |
| Cellulose/DM | 9.8% | 9.6% |
| Insoluble fibres/DM | 21.6 | 23.2 |
| Soluble fibres/DM | 1.6 | 1.2 |
| Ash/DM | 6.0% | 6.2% |
| Total sugars/DM | 0.0% | 0.1% |
| Phosphorus/DM | 1.5% | 1.5% |

The protein content of the SunPC2 concentrates obtained in this example is about 61 wt. %/DM and the residual fat is relatively high [9.8-11.4 wt. %/DM]. The sunflower concentrates were tested according to the colorimetric method described in Example 1. Lack of green colouring at pH 9 of the supernatant (light beige in these cases) demonstrates sufficient elimination of the chlorogenic acid from these two products.

4. Functional Properties of the Concentrates and Comparison with the One of Example 1 (Two Ethanol Washes) Functional properties of the SunPC2 products are reported in Table 11 below.

TABLE 11

| | | SunPC2 | SunPC2 | |
|---|---|---|---|---|
| | | (pH 6.5) | (pH 7.0) | SunPC1 |
| Water Holding Capacity (g of | | 3.6 | 3.7 | 4.7 |
| water/1 g of solids) | | | | |
| Emulsifying capacity (g of | | 175.6 | 162.6 | 157.6 |
| sunflower oil/1 g of solids) | | | | |
| Minimum gelling | % | 6% (see | 6% (See | 12% (see |
| concentration with | proteins | FIG. 8) | FIG. 7) | FIG. 6) |
| heating | % solids | 10% | 10% | 19% |

Compared to SunPC1, both SunPC2 concentrates gelled with less protein content (respectively 12% for SunPC1 and 6% for SunPC2) and have comparable oil emulsifying capacity (See FIGS. 7 (pH 7) and 8 (pH 6.5)). However, water retention capacities are lower compared to the SunPC1 concentrate. This would be due to higher residual fat content in SunPC2 as well as the single alcohol washing step.

### Example 3 Comparative Tests

In order to show the effect of the specific successive steps of the method of the invention, comparative tests were carried out. These tests, referenced PMM1 to PMM4 were carried out on sunflower meal from fully (100%) dehulled seeds which were pressed and washed in the same conditions but for the nature of the wash or sequence used. To show that a lower concentration of ethanol can be used in the alcohol wash, a concentrate SunPC3 was made according to the process of the invention using one alcoholic wash at 80% w/w ethanol. The results are shown in Table 12 below.

TABLE 12

| | | | 3rd | Protein | |
|---|---|---|---|---|---|
| | 1^{st} Wash | 2^{nd} Wash 2 | Wash | wt. %/DM | Colorimetric test |
| SunPC1 | Water, | Ethanol 96 | Ethanol 96 | 67.8 | Absence of green |
| | pH 4.8 | | | | colour/hue |
| SunPC2 | Water, | Ethanol 96, | No | 61.1 (pH 6.5) | Absence of green |
| | pH 4.8 | pH 6.5 or | | 60.6 (pH 7) | colour/hue |
| | | pH 7 | | | |
| SunPC3 | Water, pH | Ethanol 80 | No | 62.1 | Absence of green |
| | 4.8 | | | | colour/hue |
| SunPC4 | Water, pH | Water pH 7 | No | 54.0 | Not measured |
| | 4.8 | | | | |
| SunPC5 | Ethanol | Ethanol 96 | No | 64.9 | Presence of a green |
| | 80, pH 4.8 | | | | colour/hue |
| SunPC6 | Ethanol 96 | Water pH | No | 61.9 | Presence of a green |
| | | 4.8 | | | colour/hue |
| SunPC7 | Ethanol 96 | Ethanol 80 | No | 61.3 | Presence of a green |
| | | pH 4.8 | | | colour/hue |

These tests show that only the particular combination of an acidic washing step and a subsequent alcohol washing step permits to achieve a concentrate having both a high amount of protein and a low degree of chlorogenic acid.

Further tests were carried on 50% dehulled sunflower seed. The concentrate SunPC8 was obtained using a second acidic wash instead of an alcoholic wash. The results are shown in Table 13 below.

TABLE 13

| | 1st Wash | 2ndWash2 | Protein wt. %/DM | Colorimetric test |
|---|---|---|---|---|
| SunPC8 | Water pH | Water pH | 44.3* | Not measured |
| | 4.8 | 4.8 | | |

*Value measured after additional sieving steps to remove residual hull

### Example 4: Synergistic and Structural Effects of Water and Alcohol Washes on a Sunflower Protein Concentrate

Comparative tests were carried to evidence the synergetic effect of the process according to the invention, in particular of the coupling of (a) water wash(es) with (an) alcohol wash(es), on the composition and functional properties of the resulting sunflower concentrate. To show the impact of successive washings with water and then with ethanol on the physicochemical composition and on the functional properties of the final concentrate, four (04) comparative tests were carried out:

The press cake starting material used in these tests was obtained under the same conditions as in Examples 1 and 2 but the pellets were milled using a standard hammer mill and a 2 mm screen. The protocol used to carry out the washing steps is similar to that one used in Example 1 but was carried out on a smaller scale, with only 2 kg of press cake. The experimental devices used were identical to those devices used in example 2.

The composition of the press cake is presented in table 14 below

TABLE 14

| | Press |
|---|---|
| Components in weight %* | cake |
| Dry Matter | 89.95% |
| Fat (% dry matter) | 9.34% |
| Protein (% as is) | 50.4% |
| Protein (% dry matter) | 56.0% |
| Protein (% defatted dry matter) | 61.8% |
| Polyphenols (eq. gallic acid) | 2.95% |
| Phytic acid (as is) | 3.99% |
| Phytic acid (% on protein) | 7.9% |
| Ash | 7.0% |

*over total weight except specified otherwise
Protein = N × 6.25

### Test A

Test a1 (comparative example): The press cake was washed one (1×) time with water under the same conditions than the water wash of example 1. The pH was adjusted to 2 using phosphoric acid (H3PO4).

Test a3 (comparative example): The solids from test a1 were washed twice (2×) with water under the same conditions as the water wash of example 1.

Test a6 (according to the invention): The solids from test a3 were washed three (3×) times with ethanol 96% water in the same conditions as the ethanol washes of example 1.

Test B (comparative examples): The press cake was washed once (1×), Test b1, twice, Test b2, or three times, test b3, with ethanol 96% under the same conditions than the ethanol washes of example 1.

Test C (according to the invention): The protocol of example 2 was reproduced at lab scale. The final concentrate was named c3.

All solids were dried and lyophilised as disclosed above before being analysed.

### 4.1 Impact of Washing on the Physicochemical Composition of Protein Concentrates

The composition of the solids obtained after acidic water and/or ethanol 96% washes n test a, b and c and in example 5 are presented in Table 15:

TABLE 15

| | | Press | Test a | | | Test b | | | Test c | |
|---|---|---|---|---|---|---|---|---|---|---|
| | | cake | a1 | a3 | a6 | b1 | b2 | b3 | c3 | Example 5 |
| Dry matter | (%) | 89.95 | 90.63 | 92.20 | 94.40 | 94.11 | 93.30 | 92.24 | 91.43 | 91.18 |
| Protein | (% DM) | 56.0 | 58.0 | 58.0 | 72.00 | 58.0 | 66.0 | 68.0 | 73.0 | 73.0 |
| Fat | (% DM) | 9.34 | 15.01 | 18.22 | 2.75 | 3.72 | 2.14 | 1.52 | 4.05 | 3.29 |
| Phytic acid | (% DM) | 4.44 | 2.24 | 1.25 | 1.36 | 6.01 | 5.68 | 4.59 | 3.02 | n.d. |
| Total | (% DM) | 3.28 | 1.96 | 0.29 | 0.10 | 2.91 | 2.66 | 2.60 | 0.42 | 0.38 |
| phenolics | | | | | | | | | | |

DM = dry matter
n.d. = not measured

### Phenolic Compounds

The concentration of phenolic compounds in the solids is reduced by successive washes with acidic water. A reduction compared to the press cake of −40% was observed on the solids al (1.96% DM vs 3.28% DM. on press cake), −91% for a3 (0.29% DM) and −97% for a6 (0.09% DM.).

Washing the press cake with alcohol alone does not allow for sufficient removal of phenolic compounds. Theirs concentrations in the solids b1, b2 and b3 are respectively 2.91% DM, 2.66% DM and 2.60% DM against 3.28% for the press cake. The solid c3 has a concentration of phenolic compounds of 0.42% DM, i.e. a decrease of −87% compared to the press cake.

Furthermore, at pH 9, the press cake and the solids a1, b1, b2 and b3 all show a green tinge which indicates an insufficient reduction of phenolic compounds.

### Phytic Acid

Phytic acid is mainly eliminated during acidic water washes, as shown by the content of solids al (2.24% DM) and a3 (1.25%), i.e. reductions of −50% and −72%, respectively, compared to the press cake. Ethanol washes do not remove phytic acid (a6, b3 and c3 vs. a3).

### Protein Enrichment and Fat Removal

Repeated washes using acidic water (a1 vs. a3) had no significant impact on the protein enrichment of the solid (+2% DM. in absolute value compared to press cake). The additional washes using 96% ethanol (a6 and c3) produce a combined effect allowing a more significant increase of the protein content of the final concentrate (+16% DM and +17% DM, respectively, in absolute value when compared to protein content of the press cake).

Washing steps with 96% ethanol alone b, b2 and b3 allow for effective elimination of fat, i.e. −60%, −77% and −84%, respectively, when compared to the press cake. However, other water-soluble compounds are not eliminated, which leads to protein enrichment (max+12% absolute DM compared to the press cake for b3) due to the elimination of residual fat content.

### Impact of Washes on the Functional and Organoleptic Properties of the Protein Concentrate

The functional and organoleptic characteristics of the solids from tests a to c and example 5 (below) are compiled in Table 16.

TABLE 16

| | | Press | Test a | | | Test b | | | Test c | Example 5 |
|---|---|---|---|---|---|---|---|---|---|---|
| | | cake | a1 | a3 | a6 | b1 | b2 | b3 | c3 | d3 |
| WHC | (g_{water}/ | 1.5 | 1.7 | 3 | 6.9 | 2.6 | 2.8 | 3.2 | 5.8 | nd |
| | g_{solid}) | | | | | | | | | |
| Gelling | G′ start | 138 | 34 | 27 | 1126 | 860 | 971 | 361 | 448 | nd |
| properties | (Pa) | | | | | | | | | |
| | G′ end | 3733 | 615 | 5578 | 16797 | 7640 | 5400 | 6355 | 12849 | nd |
| | (Pa) | | | | | | | | | |
| Protein | pH 6 | 15 | 61 | 12 | 23 | 23 | 18 | 11 | 6 | nd |
| solubility | (%) | | | | | | | | | |
| | pH 7 | 20 | 81 | 25 | 19 | 42 | 38 | 30 | 8 | nd |
| | (%) | | | | | | | | | |
| | pH 8 | 63 | 85 | 51 | 21 | 69 | 62 | 65 | 33 | nd |
| | (%) | | | | | | | | | |
| Colour | L* | 71.2 | 65.9 | 73.9 | 81.2 | 74.2 | nd | 77.5 | 86.3 | 84.5 |
| analysis of | A* | 2.6 | 3.2 | 1.5 | 0.5 | 1.7 | nd | 1.2 | 0.5 | 0.6 |
| the powder | B* | 14.5 | 19.6 | 14.9 | 11.2 | 12.1 | | 11.0 | 12.3 | 14.4 |

### Synergistic Effect

Table 17 compile the G′ differential values Δxᵢ=The press cake G′ end, or WHC, value minus the G′ end, or WHC, value of xᵢ, wherein x=a, b or c et i=1, 2, 3 or 6) to obtain the particular effect associated with aqueous or alcoholic washing steps on their own. The value Δa1+Δb2 provides the G′ end, or WHC, value which would be expected when combining the steps water and alcoholic steps of Test c according to the invention. The value Δa3+Δb3 provides the G′ end, or WHC, value which would be expected when combining the steps water and alcoholic steps of Test a6 according to the invention. As it can be seen from Table 16, the real values are far superior to the expected ones. An unexpected synergistic effect is therefore evidenced for both gelling properties and water holding capacity of concentrates made according to the invention.

TABLE 17

| | WHC | G′ end |
|---|---|---|
| | (g_{water}/g_{solid}) | (Pa) |
| Δa1 | 0.25 | −3118 |
| Δb2 | 1.31 | 1667 |
| Δc3 | 4.28 | 9116 |
| Δa1 + Δb2 | 1.56 | −1451 |
| Δc3 − | 2.72 | 10576 |
| (Δa1 + Δb2) | | |
| Δa3 | 1.55 | 1845 |
| Δb3 | 1.72 | 2622 |
| Δa6 | 5.41 | 13064 |
| Δa3 + Δb3 | 3.27 | 4467 |
| Δa6 − | 2.14 | 8597 |
| (Δa3 + Δb3) | | |

The solids obtained were subjected to the colorimetric test at pH 9. It shows that b1 to b2 presented a dark green colour revealing the presence of chlorogenic acid. a1 had a darker colour that the press cake (that may be due to reaction products between water and chlorogenic acid). Both c3 and the concentrate of example 5 have L values markedly higher than the one that could be expected.

### Example 5: Uses of Pellets (not Milled)

The process of the invention was applied to a press cake which was not milled and the resulting data are reported above in the Tables of Example 4.
Press cake pellets obtained as described in Example 1 were directly submitted to the protocol of Example 1 but this protocol was carried out on a smaller scale, with only 1 kg of press cake. The experimental devices used were identical to those devices used in Example 2.

### REFERENCES

Février, C., G. Viroben-Gordon B. (1996)«La valeur nutritionnelle des matières protéiques végétales»Protéines végétales P. 588-590
Kyriakopoulou, K. (2019). Chapter 6: Plant-Based Meat Analogues. In: Sustainable Meat Production and Processing. Galanakis, Charis, Academic Press, ISBN 9780128148747, pp. 103-126.
Laisney, J. (1984). L'huilerie moderne. Compagnie Française pour le Développement des Fibres Textiles (CFDT).
Matthäus, B. (2012). Chapter 2: Oil Technology. In: S. K. Gupta (ed.), Technological Innovations in Major World Oil Crops, Volume 2: Perspectives, New York: NY Springer Science+Business Media, LLC, pp 23-92.
Rahma E. H. et al. (1979), “Characterization of sunflower proteins”. Journal of food science, 44: 579-582.
Rahma E. H. et al. (1981), “Removal of Polyphenols from sunflower Meal by Various Solvents: Effects on Functional Properties.” Journal of food science, 46: 1521-1522.
Saeed M. et al. (1988), “Sunflower Protein Concentrates and Isolates Low in Polyphenols and Phytate”. Journal of food science, 53. 1127-1131
Sripad G. and M. S. Narasinga Rao (1987) “Effect of Methods To Remove Polyphenols from Sunflower Meal on the Physicochemical Properties of the Proteins” J. Agric. Food Chem. 35, 962-967.
Unger, E. H. (1990). Commercial Processing of Canola and Rapeseed: Crushing and Oil Extraction. In: Shahidi F. (eds) Canola and Rapeseed. Springer, Boston, MA, pp 235-249.
World Health Organization, & United Nations University. (2007). Protein and amino acid requirements in human nutrition (Vol. 935 p50). World Health Organization.

1. A process for producing a protein concentrate from oilseed, said process comprising the successive steps of:
a) providing a press cake from oilseed, said oilseed being seeds from a plant of the genus Helianthus, said oilseed being at least partially dehulled before being pressed, wherein said press cake is not extracted with hexane;
b) washing said press cake by mixing it with a first acidic aqueous solution to obtain an aqueous-washed oilseed meal;
c) washing said aqueous-washed oilseed meal by mixing it with a first alcohol solvent, to obtain a first alcohol-washed oilseed meal, wherein said first alcohol solvent is a hydrous or a non-hydrous alcohol and has an alcohol concentration which is above 75% w/w; and
d) separating said alcohol-washed oilseed meal from said solvent to obtain said protein concentrate.

2. The process of claim 1, wherein said oilseed are kernels.

3. The process of claim 1, wherein said press cake is obtained by cold pressing said oilseed.

4. The process of claim 1, wherein the pH of acidic wash of step b) is adjusted to range from 4.4 to 5.2.

5. The process of claim 1, wherein said process comprises only one acidic washing step.

6. The process of claim 1, wherein said first alcohol solvent is a hydrous, a non-hydrous or an azeotrope mixture of alcohol.

7. The process of claim 1, wherein said first alcohol solvent is ethanol.

8. The process of claim 1, wherein step c) of said process is repeated no more than once.

9. The process of claim 1, wherein step c) is carried out at a pH of 6.5±0.2.

10. The process of claim 1, wherein said separating step comprises a drying step.

11. An oilseed protein concentrate, wherein said concentrate comprises:
a protein content of at least 55% dry matter w/w; and
a content of polyphenol compounds of less than 2% dry matter w/w;
wherein said oilseed is from a plant from the genus Helianthus.

12. The oilseed protein concentrate according to claim 11, wherein said concentrate comprises a fat content of less than 14% dry matter w/w, and optionally comprises a water holding capacity of at least 3 g/g.

13. The oilseed protein concentrate according to claim 11, wherein said concentrate is in powder form and has a L* value ranging from 81 to 100, a a* value ranging from −2.0 to +2.0 and a b* value ranging from 0 to 20.

14. A process for producing a protein concentrate from oilseed, said process comprising the successive steps of:
providing a press cake from oilseed, said oilseed being seeds from a plant of the genus Helianthus, said oilseed being at least partially dehulled before being pressed, wherein said press cake is not extracted with hexane;
washing said press cake by mixing it with a first solvent to obtain a first solvent-washed oilseed meal, wherein the phytic acid content thereof is reduced by at least 40% dry matter w/w compared to the one of said press cake, and wherein the total content of phenolic compounds thereof is reduced by at least 30% dry matter w/w compared to the one of said press cake;
washing said first solvent-washed oilseed meal by mixing it with a second solvent, to obtain a first second-washed oilseed meal, wherein the protein content thereof is increased by at least 15% dry matter w/w compared to the one of the press cake, and wherein the fat content thereof is reduced by at least 50% dry matter w/w compared to the one of the press cake; and
separating said second solvent-washed oilseed meal from said solvent to obtain said protein concentrate.

15. An oilseed protein concentrate said concentrate obtained, or obtainable, by the process of claim 1, wherein said concentrate comprises: a protein content of at least 55% dry matter w/w; and a content of polyphenol compounds of less than 2% dry matter w/w; wherein said oilseed is from a plant from the genus Helianthus.

16. A method for preparing a food product or a feed for human or animal consumption comprising adding and/or mixing the oilseed concentrate of claim 11 to another ingredient.

17. The process of claim 1, wherein said oilseed being seeds from a plant of Helianthus annuus L.

18. The process of claim 3, wherein the temperature of the oilseed during the cold pressing shall be maintained as of 80° C. or less.

19. The process of claim 1, wherein said first alcohol solvent is an azeotrope.

20. The process of claim 7, wherein said ethanol is at a concentration of 96% w/w.
